(19) United States
(12) Patent Application Publication
(10) Pub. No.: US 2026/0268663 A1
(43) Pub. Date: Sep. 10, 2026

(54) Automated Curation Of Images Based On Scene Grouping

(71) Applicant: Ikorongo Technology, LLC, Swansboro, NC (US)

(72) Inventors: Hugh Blake Svendsen, Swansboro, NC (US); Eugene Farrelly, Cary, NC (US); Kunal Kandekar, San Ramon, CA (US)

(73) Assignee: Ikorongo Technology, LLC, Swansboro, NC (US)

(21) Appl. No.: 19/659,121

(22) Filed: Apr. 27, 2026

Related U.S. Application Data
(60) Provisional application No. 64/021,319, filed on Mar. 30, 2026.
(60) Provisional application No. 63/817,658, filed on Jun. 4, 2025.

(51) Int. Cl. G06V 20/30; G06T 11/60; G06V 10/25; G06V 10/762; G06V 10/10

(52) U.S. Cl. CPC G06V 20/30; G06T 11/60; G06V 10/25; G06V 10/762; G06T 2200/24; G06V 10/17

(57) ABSTRACT

One method of using a user device to automate curation of images based on scene-based grouping comprises: obtaining a plurality of images during a capture session occurring within a geographic region; grouping at least a portion of the plurality of images into a group of images based on a scene depicted in each image within the capture session; ranking the images in the group of images based at least in part on representativeness; and in response to detecting a trigger associated with termination of the capture session, performing a trigger action using the ranking to identify at least one image from the group of images..

### BACKGROUND

### CROSS-REFERENCE TO RELATED APPLICATIONS

This application claims the benefit of U.S. Provisional Patent Application No. 63/817,658, filed June 4, 2025, and U.S. Provisional Patent Application No. 64/021,319, filed March 30, 2026. Each of the foregoing applications is hereby incorporated by reference herein in its entirety.

### Field of the Various Embodiments

Embodiments of the present disclosure generally relate to techniques for automating curation among images in a collection.

### Description of the Related Art

The widespread integration of high-resolution camera systems into smartphones and other portable electronic devices has enabled users to easily capture large quantities of high-quality digital images. This problem is further exacerbated by a tendency of users to take multiple images of the same scene in hopes of obtaining a preferred image. As image capture has become increasingly convenient and ubiquitous, users now routinely accumulate substantial collections of digital photographs on their mobile devices. This situation gives rise to the problem of how to navigate, curate, and otherwise manage large image collections, particularly on mobile devices where computing resources are more limited.

Mobile devices often operate under significant resource constraints, such as limited display size, memory capacity, and processing power. These limitations can hinder a user’s ability to effectively browse, organize, and retrieve desired images from within large image libraries. Some mobile device platforms attempt to mitigate this problem by offering organizational paradigms that assist navigation, such as organization by time, location, person, or event. Although such paradigms may help reduce the number of images initially presented to the user, further improvement is needed.

One problem with these paradigms is that they do not sufficiently reduce clutter or ease navigation at the scene level. For example, organizing images by time, location, person, or event may lead a user to a related subset of images, but may still leave the user to review multiple redundant images depicting substantially the same scene. Consequently, such approaches do not adequately reduce redundancy in either viewing or storing images.

Consequently, there exists a need for improved methods and systems for managing and interacting with extensive collections of digital images on resource-constrained devices.

### SUMMARY

As described above, users increasingly accumulate large collections of digital images on mobile devices, often including multiple images depicting the same or similar scenes. The limited display area and computational resources of such devices make traditional browsing and organization methods inefficient, particularly when users must visually sift through many similar images. The present disclosure addresses these limitations by providing improved techniques for curating and navigating large, growing image libraries.

In particular, the disclosed techniques group images into scene-based groups and determine a representative image for a given group based on one or more image characteristics, such as representativeness and/or image quality. A user interface can present the image collection using representative images for respective scene-based groups, thereby suppressing display of redundant images while preserving user access to the full set of images within each group. In this manner, the disclosed techniques reduce visual clutter, improve navigation, and conserve computational resources.

In one embodiment, the present disclosure sets forth a computer-implemented method for automating curation of images based on scene-based grouping. The method includes obtaining a plurality of images during a capture session occurring within a geographic region. The method also includes grouping at least a portion of the plurality of images into a group of images based on a scene depicted in each image within the capture session. The method further includes ranking images in the group based at least in part on representativeness. In response to detecting a trigger, the method performs a trigger action using the ranking to select at least one image from the group of images.

One advantage of the proposed techniques includes reducing clutter and redundancy when displaying and storing a collection of images, thereby facilitating ease of navigation, particularly on resource-constrained devices. Another advantage includes enabling curation activities to be presented to the user in response to one or more triggers, such that the user may be prompted to review representative images and curate redundant images at a time when the images remain current in the user’s mind and when the user is available to perform the curation.

By way of a non-limiting example, a user may capture a plurality of images using a mobile phone while spending time at a beach. During the outing, the user may capture multiple images of respective scenes, including repeated captures of substantially the same scene. Multiple images of the same scene may be taken in an effort to obtain a preferred image and also because glare at the beach can make it difficult to clearly view already captured images. After the capture activity has ended, such as when the user leaves the beach and later becomes available to review images, the mobile phone may present the captured images in a graphical user interface using representative images for respective scene-based groups. Upon selection of a representative image, the user may view additional images associated with the corresponding scene-based group. The user may then confirm the representative image, select a different representative image, delete or archive one or more redundant images, or otherwise curate the scene-based group.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a system diagram illustrating a system for facilitating curation and navigation among images based on scene-based grouping, according to one or more embodiments;

FIG. 2A is a block diagram illustrating a data structure for storing image information, according to one or more embodiments;

FIG. 2B is a block diagram illustrating a data structure for storing subject face information associated with an image, according to one or more embodiments;

FIG. 2C is a block diagram illustrating a data structure for storing capture session information associated with a plurality of images, according to one or more embodiments;

FIG. 2D is a block diagram illustrating a data structure for storing image group information associated with a scene-based group, according to one or more embodiments;

FIG. 3A is a conceptual diagram illustrating a graphical user interface for displaying images in an image collection, according to one or more embodiments;

FIG. 3B is a conceptual diagram illustrating a graphical user interface for displaying scene-based groups in a collapsed view using representative images, according to one or more embodiments;

FIG. 3C is a conceptual diagram illustrating a graphical user interface for displaying images associated with a selected scene-based group in a group view, according to one or more embodiments;

FIG. 3D is a conceptual diagram illustrating a graphical user interface for specifying a trigger definition including at least one trigger and an associated trigger action, according to one or more embodiments;

FIG. 4 is a sequence diagram illustrating interactions between a user device and a support server for grouping images, ranking images within a group, presenting representative images, and performing trigger-based curation, according to one or more embodiments;

FIG. 5 is a diagram illustrating determination of a focal location associated with a depicted scene using image information associated with a plurality of image capture locations, according to one or more embodiments;

FIG. 6 is a state diagram illustrating a workflow for trigger-based curation within the curation system, according to one or more embodiments;

FIG. 7 is a flow diagram for facilitating navigation among images using scene-based grouping and representative-image presentation, according to one or more embodiments;

FIG. 8 is a flow diagram for managing an image collection using clustering, ranking, trigger detection, and trigger-based action, according to one or more embodiments;

FIG. 9 is a block diagram illustrating computing device hardware architecture, according to one or more embodiments; and

FIG. 10 is a block diagram illustrating computing device software architecture, according to one or more embodiments.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### DEFINITIONS

Certain terms are described below to facilitate understanding of the disclosed techniques. The descriptions are intended to provide examples and context for the terms as used in this specification. Unless explicitly stated otherwise, the descriptions should not be interpreted as limiting the scope of the claims.

As used herein, a scene refers to visual subject matter, environment, composition, focal region, or other depicted content represented in an image. A scene may be represented by a single image or by multiple images that depict substantially the same subject matter. Multiple images captured from different locations, viewpoints, devices, or times may nevertheless depict the same scene when the images are determined to relate to a common subject, landmark, structure, activity, environment, or visual composition. In some embodiments, a determination that multiple images depict the same scene may be based on one or more of visual similarity, subject information, spatial information, capture metadata, contextual information, or other factors.

As used herein, a subject refers to an identifiable person, object, landmark, structure, animal, or other element appearing within an image.

As used herein, a n image group, scene-based group, cluster, or group of images refers to a collection of images that the system determines to be associated with a common scene. Image groups may be generated using one or more of visual characteristics, subject information, spatial information, contextual information, temporal relationships, metadata, or other image attributes. In some embodiments, an image may belong to one image group, multiple image groups, or no image group.

As used herein, a representative image refers to an image selected (determined, identified) to visually represent an image group within a graphical user interface. The representative image may be selected based on ranking of images in the group using one or more criteria such as image quality, representativeness, subject presence, composition, or other evaluation metrics.

As used herein, a redundant image refers to an image that is sufficiently similar to one or more other images in the same image group such that the image provides limited additional informational value relative to those images. Redundant images are not necessarily identical duplicates, but may include images that depict substantially similar scenes, viewpoints, timing, or subjects.

As used herein, an image collection refers to a set of images stored or accessible within a computing system. The image collection may reside locally on a user device, remotely on a server, or across multiple storage locations.

As used herein, a capture location refers to a geographic location associated with an imaging device at the time an image is captured. Capture location information may include coordinates such as latitude, longitude, altitude, or other positional information, and represents the physical position of the imaging device during capture.

As used herein, a focal location refers to an estimated location associated with a subject, landmark, structure, region, or other depicted scene content toward which an imaging device was directed when capturing an image. The focal location is distinct from the capture location. In some embodiments, focal location information may be used to improve determination that multiple images correspond to a common scene. A viewing vector refers to a directional representation indicating the direction in which an imaging device was oriented when capturing an image. In some embodiments, the viewing vector may be determined using orientation information and may be used, alone or in combination with other information, to estimate a focal location or to determine relationships between images captured from different positions.

As used herein, a capture session refers to a continuous or related interval during which a plurality of images are captured by a user device. In some embodiments, a capture session may be identified based on one or more cohesion signals, such as temporal proximity, spatial proximity, device or application context, motion continuity, content continuity, user interaction markers, or other contextual indicators. A geographic region refers to a geographic area associated with a capture session and may be determined from one or more capture locations associated with images in the capture session. A geographic region may provide contextual boundaries for captured images and may encompass multiple distinct scenes and multiple capture locations.

As used herein, a ranking refers to an ordering, scoring, or prioritization of images within an image group. Ranking may be based on one or more criteria including representativeness, image quality, composition, subject prominence, redundancy, or user preferences. Representativeness refers to a measure of a degree to which an image reflects common or characteristic content of an image group and is suitable for use in representing the group. In some embodiments, representativeness may be determined by the system based on one or more factors including similarity to other images in the group, similarity to a cluster centroid or aggregate embedding, subject correspondence, or other evaluation criteria.

As used herein, an embedding refers to a feature representation of an image, such as a numerical vector, that encodes one or more characteristics of the image in a form usable for similarity determination, grouping, ranking, or other analysis.

As used herein, an aggregate embedding refers to a feature representation generated from embeddings associated with multiple images in an image group, where the feature representation summarizes shared characteristics of the multiple images and may be used to assess representativeness, similarity, or group membership.

Additional terms may be described elsewhere in this specification in the context of particular embodiments.

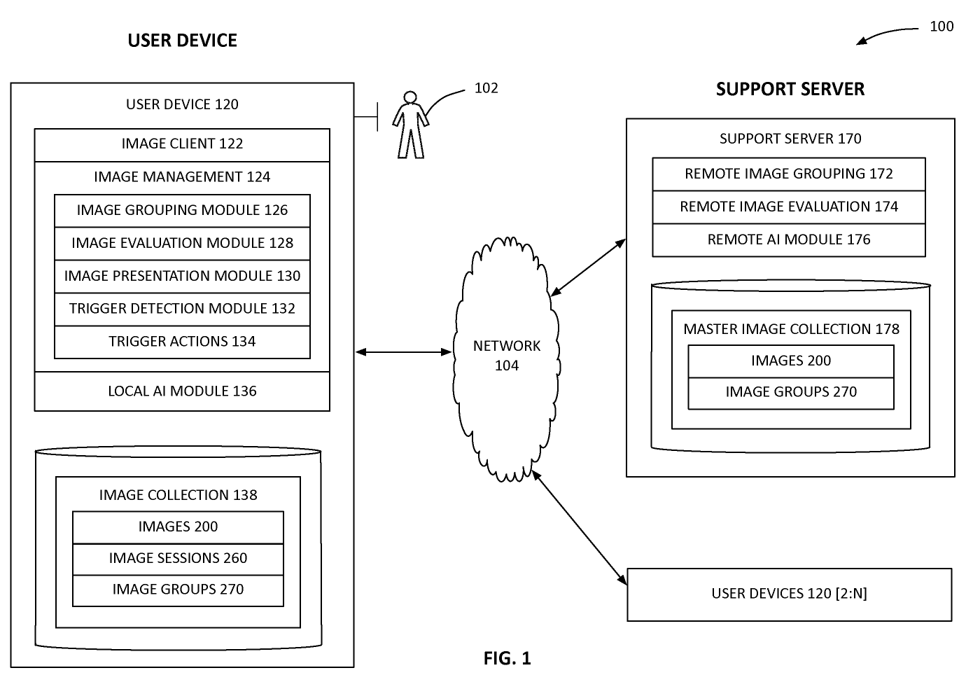

FIG. 1 is a system diagram illustrating a system 100 for facilitating curation and navigation among images based on scene-based grouping, according to one or more embodiments. The system 100 is configured to organize, evaluate, and present images in a manner that enhances user interaction with large image collections.

In one embodiment, the system 100 includes a user device 120 communicatively coupled to a support server 170 through a network 104. The network 104 may comprise one or more wired or wireless communication networks, including local area networks, wide area networks, cellular networks, and/or the Internet. The user device 120 may include, without limitation, a smartphone, tablet, laptop computer, desktop computer, or other computing device capable of storing and displaying digital images.

In certain embodiments, images are grouped based on scene similarity using one or more visual characteristics, subject-based attributes, spatial information, contextual information, metadata, or other image attributes. In some embodiments, image embeddings determined by an AI module or the like, are compared using cosine similarity to form clusters. In some embodiments, grouping may further account for an inferred subject location or focal location derived from viewing geometry associated with image capture, such that images depicting a common scene may be grouped even when the corresponding capture devices are located at different geographic positions.

The user device includes image client 122. The image client 122 includes any application or system component utilizing image management module 124.

The user device 120 also includes an image management module 124 configured to manage operations relating to grouping, evaluating, presenting, and curating images. In the illustrated embodiment, the image management module 124 includes an image grouping module 126, an image evaluation module 128, an image presentation module 130, a trigger detection module 132, and associated trigger actions 134. The image grouping module 126 is configured to group images based on scene similarity and related attributes. The image evaluation module 128 is configured to assess images within a group, determine rankings, and identify a representative image. The image presentation module 130 is configured to render images and scene-based groups on a display of the user device 120. The trigger detection module 132 is configured to detect specified conditions and initiate corresponding actions defined within the associated trigger actions 134.

The user device 120 further includes a local AI module 136 configured to perform artificial intelligence operations locally on the user device 120. The local AI module 136 may operate independently or in cooperation with a remote AI module 176. In certain embodiments, processing tasks may be selectively allocated between the local AI module 136 and the remote AI module 176 based on connectivity status, computational resource availability, privacy considerations, policy rules, or current device conditions.

In certain embodiments, artificial intelligence models used by the remote AI module 176 may be periodically updated using aggregated training data derived from multiple user devices 120 while preserving privacy constraints. Updated models may be transmitted to user device 120 and utilized by local AI module 136 to improve grouping accuracy, representative-image selection, ranking accuracy, or trigger-based curation operations.

The user device 120 stores images within an image collection repository 138. The image collection repository 138 includes stored images 200 and associated metadata. The image 200 structure may include, without limitation, capture time, geographic location, device information, extracted visual features, subject identifiers, and quality metrics.

The image collection 138 can also be maintained at the support server 170 as master image collection 178. Master image collection 178 can serve as a sync point, where multiple user devices 120 operated by the same user 102 upload images to and download images from to maintain a unified version of the image collection 138 across multiple user devices 120.

The image collection repository 138 further stores information relating to image group 270 and associated metadata. Each image group 270 includes data identifying the images 200 included within the image group 270. The image group 270 further stores information associated with the group, including the identification of a representative image selected for the group. In certain embodiments, the representative image is used as a visual placeholder when the image group 270 is presented in a user interface.

The remote AI module 176 resides at the support server 170 and is configured to perform artificial intelligence operations on behalf of the user device 120. The remote AI module 176 may process image data, generate embeddings, evaluate images, perform grouping operations, or execute other AI-based functions as described herein. Communication between the user device 120 and the remote AI module 176 occurs via the network 104.

In various embodiments, the image grouping module 126 of the image management module 124 is configured to group digital images 200 stored within the image collection repository 138 into clusters based on scene similarity. The image grouping module 126 operates on previously stored digital images and does not require control over the original image capture process. Each image 200 is analyzed to derive one or more attributes that collectively characterize the depicted scene. Based on such attributes, the image grouping module 126 assigns images 200 to one or more image group 270 representing images that depict the same or substantially similar scene.

The image grouping module 126 is configured to perform feature extraction, feature vector construction, similarity determination, clustering, and optional cluster refinement. The module may be implemented in software, hardware, or a combination thereof, and may execute on the user device 120, in cooperation with the remote AI module 176 at the support server 170 via network 104, or in a distributed configuration.

The image grouping module 126 extracts visual scene features from each image 200. In certain embodiments, a trained machine learning model generates a numerical embedding representing scene content. The embedding may encode spatial layout, object presence and arrangement, texture characteristics, color distribution, and lighting conditions. The resulting embedding vector represents the image in a latent feature space suitable for similarity comparison.

The image grouping module 126 may further extract geographic attributes from image 200 data structure, including latitude, longitude, altitude, timestamp information, and derived semantic location descriptors. Geographic similarity may be computed using geodesic distance calculations and incorporated into clustering determinations to influence grouping proximity.

Additionally, the image grouping module 126 may detect and analyze faces or other identifiable subjects within images 200. Facial recognition processes may generate embedding vectors corresponding to detected individuals. Images containing matching or substantially similar facial embeddings may be weighted toward inclusion within a common image group 270.

Following extraction of visual, geographic, and subject-based attributes, the image grouping module 126 constructs composite feature vectors and computes similarity relationships. Similarity may be determined using weighted combinations of visual similarity, geographic proximity similarity, and subject identity similarity. Weighting parameters may be predefined, user-adjustable, or adaptively learned.

The image grouping module 126 applies one or more clustering algorithms to assign images 200 to image group 270. Clustering techniques may include K-means, hierarchical clustering, density-based clustering, spectral clustering, probabilistic models, or graph-based community detection. In certain embodiments, clustering may occur in multiple stages, including initial geographic grouping followed by refinement using visual and subject-based similarity.

In certain embodiments, clustering operations are performed incrementally as new images are captured or received rather than recomputing clusters across the entire image collection. The image grouping module 126 can evaluate newly added images relative to previously stored group metadata and determine whether the newly added image should be inserted into an existing group or used to create a new group. This incremental processing reduces computational overhead and allows the system 100 to maintain updated scene groupings without repeatedly analyzing the full image collection.

The image grouping module 126 may optionally perform dimensionality reduction and support incremental updating, such that newly added images 200 are evaluated and assigned to existing or newly formed image group 270 without recomputing the entire repository.

In an alternative embodiment, grouping functions can be performed by the local AI module of the user device 120 and/or by the remote AI module 176 residing at the support server 170. The AI module may generate scene-based grouping decisions using multimodal inference, dynamically allocating processing across local and remote resources based on connectivity, resource availability, privacy policies, or system conditions.

The image evaluation module 128 of the image management module 124 is configured to analyze images 200 within an image group 270 and to identify a representative image for that group. The representative image is identified in the image group 270 metadata and may be used as a placeholder when the image group 270 is presented within a user interface.

The image evaluation module 128 computes quality scores for images 200 within a group. Quality metrics may include resolution, sharpness, focus accuracy, exposure balance, dynamic range, noise level, color balance, contrast, and composition metrics such as subject alignment and absence of motion blur. In certain embodiments, machine learning models may generate aesthetic or perceptual quality scores.

The image evaluation module 128 further computes a representativeness score for each image 200 relative to the corresponding image group 270. Representativeness may be determined by measuring similarity between an image feature vector and a cluster centroid or aggregate embedding. Images exhibiting minimal aggregate distance to other images in the group may be considered highly representative.

A composite representative score may be computed as a weighted combination of quality and representativeness metrics. The representative image may be selected as the image having the highest composite score, subject to minimum threshold criteria. If no image satisfies predefined quality thresholds, selection may default to the image most closely approximating the cluster centroid.

In certain embodiments, the image presentation module 130 may prompt a user to confirm, modify, or override the representative image designation. User selections may be stored and used to adjust scoring parameters in subsequent evaluations.

In alternative embodiments, evaluation functions are performed by the local AI module of the user device 120 and/or the remote AI module 176 at the support server 170. The AI module may perform multi-modal reasoning to assess image quality and representativeness and select the representative image using learned inference techniques. The selected representative image is stored within the image group 270 metadata.

The image presentation module 130 of the image management module 124 is configured to render the image collection repository 138 on a display of the user device 120. The image presentation module 130 may present images 200 individually, an organized image group 270, or any combination thereof.

In a grouped presentation mode, each image group 270 is visually represented using its associated representative image 286. The representative image may serve as a thumbnail, cover tile, or preview indicator.

Upon user selection of an image group 270, the image presentation module 130 transitions to a group-level view in which constituent images 200 are displayed. The representative image 286 may be distinguished visually by highlighting or labeling.

In the group-level view, image 200 may be displayed based on scores assigned by the image evaluation module 128. Images may be ranked by composite representative score, with higher-scoring images presented more prominently. Lower-scoring images may be visually deemphasized.

The image presentation module 130 may further generate interface indicators recommending deletion or archival of lower-scoring or redundant images. As used herein, a “redundant image” refers to an image that is sufficiently similar to another image within the same image group such that the image contributes limited additional informational value. For example, images having similarity above a redundancy threshold and quality below a predefined threshold may be flagged. The user may be provided with options to delete, archive, retain, or review such images.

The image presentation module 130 may dynamically update displays in response to deletions, regrouping, or recalculation of representative images.

The trigger detection module 132 of the image management module 124 is configured to monitor device states, image lifecycle events, and user-defined conditions, and to initiate corresponding actions defined within associated trigger actions 134.

The trigger detection module 132 detects geographic state transitions, including a state in which the user device 120 exits a geographic area of capture associated with one or more images 200. The module may also detect that a predetermined period of time has elapsed since departure from such geographic area.

The trigger detection module 132 monitors storage capacity of the user device 120 and detect when available storage falls below a threshold.

The trigger detection module 132 can further detect image lifecycle events, including capturing an image, deleting an image, modifying an image, or receiving an image from an external source via network 104.

The trigger detection module 132 evaluates user-defined rules specifying trigger conditions. Upon detecting satisfaction of a trigger condition, the module may execute one or more associated trigger actions 134.

Trigger actions 134 can include deleting one or more images 200 to free storage space, causing the image grouping module 126 to regroup images 200 into image group 270, causing the image evaluation module 128 to compute or recompute a representative image, prompting user confirmation of a representative image, or executing other user-specified workflows.

By separating trigger detection from responsive execution, the trigger detection module 132 enables event-driven operation of the image management module 124, supporting automated regrouping, representative image updating, storage optimization, and rule-based automation within the system illustrated in FIG. 1.

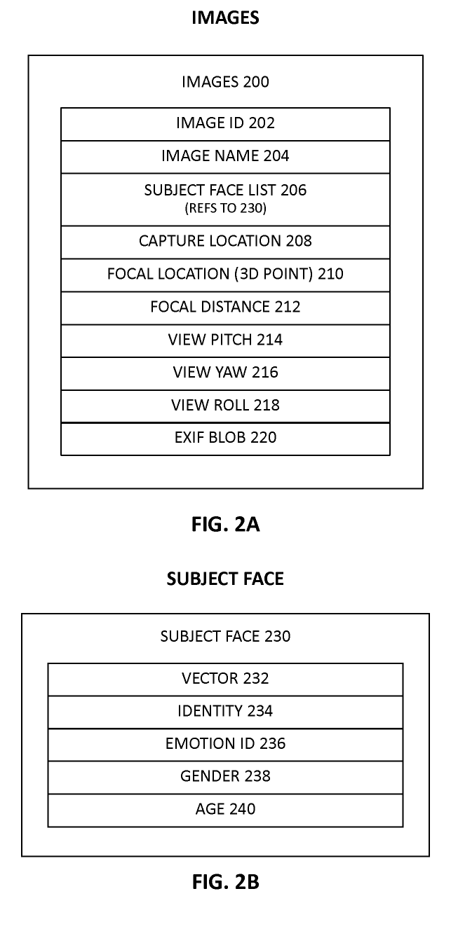

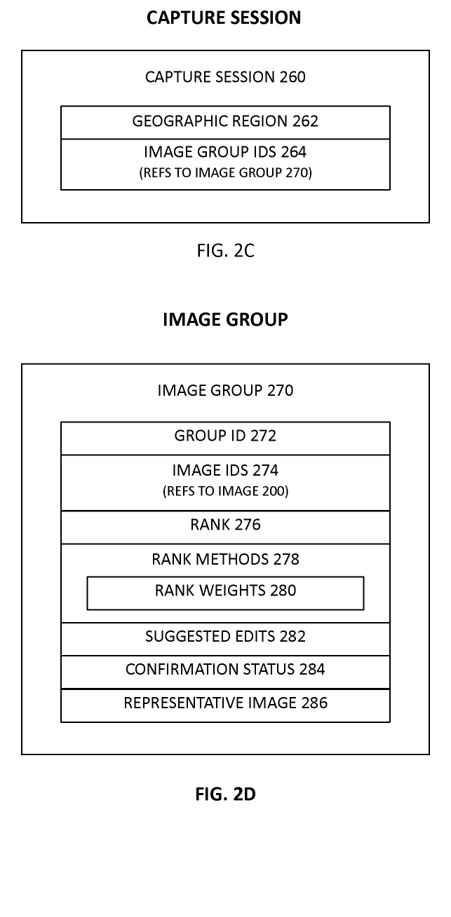

FIG. 2A is a block diagram illustrating a data structure for storing image 200 information, according to one or more embodiments. The image 200 data structure may be stored within the image collection repository 138 of the user device 120 and/or within a remote storage system accessible via network 104. The stored information is structured to facilitate scene-based grouping, subject identification, spatial reasoning, orientation-aware similarity determination, and automated image management operations.

The image 200 data structure includes an image ID 202, an image name 204, a face list 206, a capture location 208, a focal location 210, a focal distance 212, a view pitch 214, a view yaw 216, a view roll 218, and an EXIF blob 220.

The image ID 202 uniquely identifies the image 200 within the system 100 and may comprise a globally unique identifier (GUID), a hash derived from image content, or another unique token. The image name 204 stores an alphanumeric identifier associated with the image and may correspond to a file name or user-defined label.

The face list 206 stores representations of subject faces appearing in the image 200. In certain embodiments, facial detection and embedding generation processes produce vector representations for each detected face. Each entry in the face list 206 may include a facial embedding vector, bounding region information, confidence metrics, and optionally a subject identifier. These facial embeddings enable subject-based clustering and representativeness analysis.

The capture location 208 stores a normalized geographic representation of the device position at the time the image was captured. The capture location 208 may include latitude, longitude, altitude, and timestamp information. In certain embodiments, the capture location 208 may be derived from raw metadata stored in EXIF blob 220 and normalized into a structured coordinate format for efficient indexing and comparison. The capture location 208 represents the physical position of the imaging device and is distinct from the focal location 210.

The focal location 210 stores a geographic location corresponding to the primary scene depicted in the image 200. Unlike the capture location 208, the focal location 210 represents the estimated location of the scene toward which the device was directed. The focal location 210 may be computed using a viewing vector derived from orientation parameters 214–218 in combination with capture location 208 and focal distance 212. In certain embodiments, focal location 210 may be estimated using depth data, landmark recognition, triangulation techniques, or computer vision-based inference. The distinction between capture location 208 and focal location 210 enables grouping of images taken from different physical positions but directed toward a common scene.

In some embodiments, focal locations 210 may be determined using capture geometry associated with multiple images. For example, a user device 120 may record geographic capture coordinates and camera orientation information, such as heading or viewing direction, when each image is captured. Using this information, a viewing vector may be projected from the capture location of each image into three-dimensional space corresponding to the direction in which the camera was oriented during capture. When multiple images depict the same subject or scene element, the projected viewing vectors associated with those images may intersect or converge near a common point in space corresponding to the focal location. The focal location may therefore be estimated by identifying an intersection point or a point that minimizes the distance between two or more viewing vectors within a threshold tolerance.

In some embodiments, determining that viewing vectors correspond to a common focal location may include identifying a point in space that minimizes distances between the viewing vectors, determining a closest point between the vectors, computing a least-squares intersection of the vectors, or otherwise determining a spatial location toward which the vectors substantially converge.

The focal distance 212 stores an estimated distance between the capture location 208 and the focal location 210. The focal distance 212 may be determined using device-reported focus parameters, depth sensor measurements, lidar data, or vision-based range estimation. The focal distance 212 may support perspective-aware grouping and differentiation between foreground and background subjects.

The view pitch 214, view yaw 216, and view roll 218 store orientation parameters of the capture device at the time of image acquisition. The view pitch 214 represents vertical viewing angle, the view yaw 216 represents horizontal direction relative to a geographic reference, and the view roll 218 represents rotation about the viewing axis. These orientation parameters may be derived from inertial measurement unit (IMU) data, gyroscope readings, compass data, or sensor fusion algorithms. In certain embodiments, raw orientation data may be obtained from EXIF blob 220 and transformed into normalized angular values stored in fields 214–218. The structured orientation fields enable orientation-aware clustering and improved estimation of focal location 210.

In certain embodiments, scene grouping performed by image grouping module 126 may be based on one or more attributes associated with the images, including visual scene characteristics, subject information, contextual information, metadata, or spatial information. Conventional image organization systems typically group images according to capture time and device location. However, multiple images captured from different physical positions can depict the same subject, landmark, or scene. In some embodiments, to address this scenario, system 100 can determine a viewing vector for each image using capture location 208 together with orientation parameters including view pitch 214, view yaw 216, and view roll 218, and optionally focal distance 212. The viewing vector can be projected outward from the capture location 208 to estimate focal location 210 corresponding to the depicted scene or subject of the image. When viewing vectors associated with multiple images intersect or converge within a threshold region, image grouping module 126 can determine that the images depict a common scene even though the capture locations 208 and capture times differ. This approach can support grouping of images captured from different viewpoints, distances, or times according to a shared depicted scene.

The EXIF blob 220 stores raw metadata associated with the image 200 as captured by the imaging device. The EXIF blob 220 may include, without limitation, timestamp information, device-reported GPS data, camera settings, exposure parameters, sensor readings, and other standard EXIF attributes. The EXIF blob 220 may also include extended metadata formats such as XMP data or device sensor logs. In certain embodiments, values contained within the EXIF blob 220 are parsed, normalized, and used to populate structured fields including capture location 208 and orientation parameters 214–218. The EXIF blob 220 thus preserves original metadata in raw form while enabling the system 100 to derive structured, system-level attributes optimized for grouping and evaluation operations.

By separating raw metadata (EXIF blob 220) from normalized and derived fields such as capture location 208, focal location 210, focal distance 212, and orientation parameters 214–218, the image 200 data structure supports both compatibility with conventional imaging standards and enhanced spatial reasoning capabilities. This layered structure enables the image grouping module 126 to perform scene grouping based on scene-related attributes that may include device location, timestamp, inferred subject location, viewing direction, subject identity, visual features, or other contextual information. The structure further supports evaluation by image evaluation module 128 and trigger-based operations by trigger detection module 132.

In certain embodiments, additional fields may be incorporated into the image 200 data structure, including visual scene embeddings, quality scores, redundancy indicators, or artificial intelligence model identifiers, without departing from the structural framework illustrated in FIG. 2A.

In certain embodiments, the system 100 may determine that images captured from different device locations correspond to the same scene by analyzing the viewing vectors associated with the images. A viewing vector may be derived from a combination of capture location 208, focal distance 212, and orientation parameters including view pitch 214, view yaw 216, and view roll 218. By projecting the viewing vectors outward from their respective capture locations, the system may estimate a common focal region or focal location 210 toward which multiple images are directed. When viewing vectors from multiple images intersect within a threshold geographic region, the image grouping module 126 may determine that the images depict the same subject or landmark even if the images were captured from different physical positions.

By way of example, multiple users located at different positions throughout a geographic region may capture images directed toward the same scene, such as the Eiffel Tower. Although the respective capture locations of the devices may differ substantially, the viewing directions associated with the captured images may converge toward a common focal region corresponding to the landmark. The system can determine that the images depict the same scene based at least in part on the inferred focal location, optionally in combination with one or more additional scene-grouping signals. As a result, images captured from different viewpoints, distances, or times can be grouped into a common image group representing the landmark.

In another illustrative scenario, multiple users positioned at different locations within or around a stadium may capture images directed toward a scene located on the playing field, stage, or other central subject during an event. Although the capture locations of the respective devices may vary significantly, the viewing directions associated with the captured images may converge toward a focal region corresponding to the field or stage. The system can determine that the images are related to the same scene based at least in part on the inferred focal location, optionally in combination with other scene-based grouping criteria, and can group the images accordingly even when the images originate from different seating areas, distances, or times.

Similar techniques can be applied to other landmarks, structures, landscapes, or subjects that are photographed from multiple viewpoints.

In certain embodiments, scene clustering performed by image grouping module 126 may account for convergence of viewing vectors associated with multiple images rather than relying solely on geographic proximity of capture locations. This approach can enable grouping of images that depict the same subject even when the capture devices are separated by a significant distance. In some embodiments, convergence of viewing vectors may be used as one grouping signal among multiple scene-based grouping signals.

FIG. 2B is a block diagram illustrating a data structure for storing subject face 230 information associated with an image, according to one or more embodiments. The subject face 230 data structure is configured to store structured facial analysis information derived from image content and to facilitate grouping, clustering, and similarity determination across multiple images. Each detected face within an image 200 may correspond to a separate instance of subject face 230 data structure stored within the face list 206.

The subject face 230 data structure includes a facial embedding vector 232, an optional identity field 234, an emotion identifier 236, a gender identifier 238, and an age indicator 240.

The facial embedding vector 232 comprises a multi-dimensional numeric representation generated using facial analysis techniques. The embedding vector 232 may be produced by a neural network trained for facial recognition or facial feature extraction. The vector 232 encodes distinctive facial characteristics such that similarity between faces may be determined by comparing corresponding embedding vectors using distance metrics such as cosine similarity or Euclidean distance. The embedding vector 232 enables determination that two images contain the same individual, even if the individual's identity is not known or explicitly labeled.

The identity field 234 is optional and may store an identifier corresponding to a recognized individual. The identity field 234 may include a user-assigned name, a system-generated subject ID, or a reference to a subject record stored elsewhere in the system 100. In certain embodiments, grouping and clustering operations rely solely on similarity between embedding vectors 232 without requiring a populated identity field 234. Accordingly, explicit identification of the individual is not required to determine that the same person appears in multiple images. The identity field 234 may be populated after sufficient similarity matches have been detected or upon user confirmation.

The emotion identifier 236 stores an inferred emotional state of the detected subject at the time of capture. The emotion identifier 236 may be derived using facial expression analysis techniques and may represent categories such as neutral, smiling, laughing, surprised, or other emotion classes. The emotion identifier 236 may support clustering of images based on expression similarity, quality evaluation (e.g., preferring smiling faces for representative selection), or filtering operations within a user interface.

The gender identifier 238 stores an inferred gender classification associated with the detected face. The gender identifier 238 may be determined using facial attribute analysis techniques and may represent probabilistic or categorical outputs. In certain embodiments, the gender identifier 238 may assist in grouping images based on demographic characteristics or refining similarity matching.

The age indicator 240 stores an estimated age or age range corresponding to the detected subject. The age indicator 240 may be generated using facial age estimation techniques and may be represented as a numeric estimate or categorical age range. The age indicator 240 may facilitate temporal grouping of images (e.g., identifying images of a subject at similar life stages) and may improve representativeness scoring within image group 270.

The fields of the subject face 230 data structure may be estimated using conventional facial detection, facial recognition, and facial attribute analysis techniques. In certain embodiments, the facial embedding vector 232 serves as the primary mechanism for matching faces across images, while the identity field 234 remains optional and may be omitted when identity determination is unnecessary or undesired. The additional facial attributes stored in fields 236–240 provide enhanced contextual signals that may be used by image grouping module 126 and image evaluation module 128 to improve scene-based clustering, representative image selection, and redundancy analysis.

By structuring subject face information in the manner illustrated in FIG. 2B, the system 100 supports identity-independent face matching, attribute-aware grouping, and adaptive evaluation of images containing recurring subjects, thereby enhancing clustering accuracy and curation quality across the image collection repository 138.

FIG. 2C is a block diagram illustrating a data structure for storing capture session 260 information associated with a plurality of images, according to one or more embodiments. FIG. 2C illustrates an example organizational structure for associating scene-based image groups with contextual capture information. In some embodiments, captured images may be organized using multiple levels of contextual information including a capture session 260, a geographic region 262, and one or more image group references 264.

The capture session 260 may represent a continuous activity interval during which a plurality of images are captured by a user device 120. The capture session 260 may correspond to a user activity or event, such as attending a concert, visiting a beach, participating in a sporting event, touring a location, or engaging in another experience during which multiple images are captured over a period of time. In some embodiments, the capture session 260 may be identified using a session cohesion condition evaluated from multiple signals associated with the captured images and the user device. For example, the system may evaluate signals including temporal proximity between captured images, spatial proximity between capture locations, device or application context, motion state continuity of the user device, environmental context continuity, content continuity between images, and user interaction markers.

In some embodiments, the session cohesion condition may be determined by computing a session cohesion score based on a weighted combination of such signals. Each signal may contribute a corresponding continuity indicator reflecting whether images are likely associated with the same capture session. The session cohesion score may be computed by combining these indicators using a weighting scheme that may be predetermined, dynamically adjusted based on device conditions, or learned using machine learning techniques. When the session cohesion score exceeds a threshold value, the corresponding images may be assigned to the capture session 260. Conversely, when the score falls below the threshold or a discontinuity is detected between sequentially captured images, a boundary between capture sessions may be identified.

The signals described above are illustrative and not limiting, and other signals indicative of continuity of capture activity or user context may also be evaluated when determining the session cohesion condition.

The geographic region 262 may represent a geographic area associated with the capture session 260. In some embodiments, the geographic region 262 may be derived from geographic coordinates associated with the captured images. Image capture devices such as smartphones, tablets, or cameras may embed geographic coordinates (e.g., latitude and longitude) within metadata associated with captured images. The system may analyze the geographic coordinates of multiple captured images to determine the geographic region 262 corresponding to the capture session.

In some implementations, the geographic region 262 may be determined by computing a spatial boundary that encompasses the geographic coordinates of the captured images. For example, the geographic region 262 may be represented by a bounding region, convex hull, centroid with a radius, or other spatial enclosure representing the area in which capture activity occurred. The geographic region 262 may correspond to a venue-level geographic area in which the capture activity occurred, such as a stadium, park, beach, concert venue, museum, tourist attraction, or other location where the user captures images during the capture session 260. The geographic region 262 may encompass multiple viewpoints or capture locations within the broader geographic area.

The image group references 264 may identify scene-based image groups previously determined by the system 100, such as the image groups described with reference to FIG. 2D. Each image group reference 264 may correspond to one of the image groups 270 and may therefore identify a set of images depicting a common scene, subject, or focal location. In this manner, the capture session 260 and geographic region 262 may be associated with multiple image groups through the image group references 264.

For example, during a capture session occurring at a sporting event, a user may capture images of the playing field, teammates, the scoreboard, and surrounding scenery. Scene analysis may organize these images into separate image groups 270 as described with respect to FIG. 2D.

Accordingly, multiple image groups may be associated with the same capture session 260 and geographic region 262 through the image group references 264. This structure enables the system to maintain scene-based grouping of images while also preserving higher-level contextual information describing the capture activity and geographic environment in which the images were captured.

This multi-level organization allows the system to distinguish between event-level capture activity, represented by the capture session 260, geographic context, represented by the geographic region 262, and scene-based groupings of images, represented by the image groups 270 referenced by the image group references 264. Such separation enables efficient organization and navigation of captured images while supporting automated curation operations based on scenes depicted within the images.

In some embodiments, the capture session 260 and geographic region 262 may be determined prior to or concurrently with the generation of image groups 270.

In some embodiments, a single capture session may include images depicting multiple scenes or focal locations within the same geographic region, and the system may generate separate image groups corresponding to the different scenes.

FIG. 2D is a block diagram illustrating a data structure for storing image group information associated with a scene-based group, according to one or more embodiments. The image group 270 data structure may be stored within the image collection repository 138 and corresponds to an image group 270 as referenced elsewhere herein. The image group 270 data structure enables structured storage of group membership, ranking logic, evaluation outputs, and user interaction status associated with clustered images.

The image group 270 data structure includes a group ID 272, image IDs 274, rank data 276, rank methods 278, associated rank weights 280, suggested edits 282, confirmation status 284, and representative image 286.

The group ID 272 uniquely identifies the image group within the system 100. The group ID 272 may comprise a globally unique identifier, a hash derived from grouped image attributes, or another system-generated token. The group ID 272 enables association between grouped images and corresponding group-level metadata 274-284 and supports indexing, retrieval, and cross-referencing.

The image IDs 274 comprise a list, array, or indexed collection of identifiers corresponding to one or more images that are members of the group. Each entry in image IDs 274 references an image ID 202 stored within image 200 data structure (FIG. 2A). The image IDs 274 field therefore establishes explicit membership of the image group and enables efficient traversal and updating of group contents.

The rank data 276 stores ranking results for images within the group. In certain embodiments, rank data 276 may include a ranked list of image IDs ordered according to composite representative score, quality score, representativeness score, or other evaluation metrics generated by image evaluation module 128. Rank data 276 may further include per-image ranking values or relative position indices. The highest-ranked image within rank data 276 may be designated as the representative image 286 for the group, while lower-ranked images may be candidates for archival or deletion.

The rank methods 278 identify one or more ranking methods used to compute ranking positions stored in rank data 276. The rank methods 278 may include identifiers corresponding to ranking algorithms such as quality-based scoring, centroid proximity scoring, subject-priority scoring, recency weighting, or composite scoring. By explicitly storing the rank methods 268 used to produce the ranking, the system 100 preserves traceability and enables recalculation or comparison across alternative ranking strategies.

The associated weights 280 store weighting parameters applied to one or more rank methods 278. For example, associated weights 280 may specify the relative contribution of image quality score versus representativeness score in computing composite rank values. In certain embodiments, the associated weights 280 may be static, dynamically adjusted, or modified in response to user override behavior. Storing associated weights 280 within the image groups 270 data structure allows for reproducibility of ranking decisions and supports adaptive learning.

The suggested edits 282 store zero or more recommended actions generated by image evaluation module 128 or trigger detection module 132. Suggested edits 282 may include, without limitation, identification of a proposed representative image 286, identification of images suggested for deletion due to redundancy or low score, recommendations for cropping or enhancement, or regrouping recommendations. Each suggested edit entry may reference one or more image IDs and may include a suggested action type, priority level, and explanatory metadata.

The confirmation status 284 stores information indicating whether any of the suggested edits 282 have been confirmed, rejected, or modified by the user. The confirmation status 284 may include per-edit status indicators, timestamps of user interaction, and user override data. In certain embodiments, confirmation status 284 may be used to update rank weights 280 or adjust ranking methods 278 in future evaluations. The confirmation status 284 therefore enables a feedback loop between user interaction and automated evaluation logic.

Representative image 286 may comprise a selected image associated with an image group and configured to serve as a visual proxy for the image group within the user interface. In some embodiments, representative image 286 may be selected from a plurality of images included in the image group based on one or more criteria, including spatial proximity to a focal location associated with the image group, visual quality metrics, detected scene characteristics, presence of a primary subject, temporal position within a capture session, or combinations thereof. Representative image 286 may be displayed to represent the image group in a condensed browsing view, such that user interaction with representative image 286 causes presentation of additional images corresponding to the image group. In this manner, representative image 286 may improve interface efficiency by reducing the number of images that must be concurrently displayed while still conveying the content of the associated group. In some embodiments, the representative image 286 is generated based on the images in the group using an AI module such as local module 136 and/or remote AI module 176.

Collectively, the image groups 270 data structure provides a structured mechanism for storing group membership, ranking logic, ranking outputs, recommended actions, and user confirmation states. By persisting both ranking inputs (methods 278 and weights 280) and ranking outputs (rank data 276), the system 100 supports reproducibility, auditability, adaptive refinement, and event-driven automation. The image groups 270 data structure thereby enables coordinated operation of the image grouping module 126, image evaluation module 128, image presentation module 130, and trigger detection module 132.

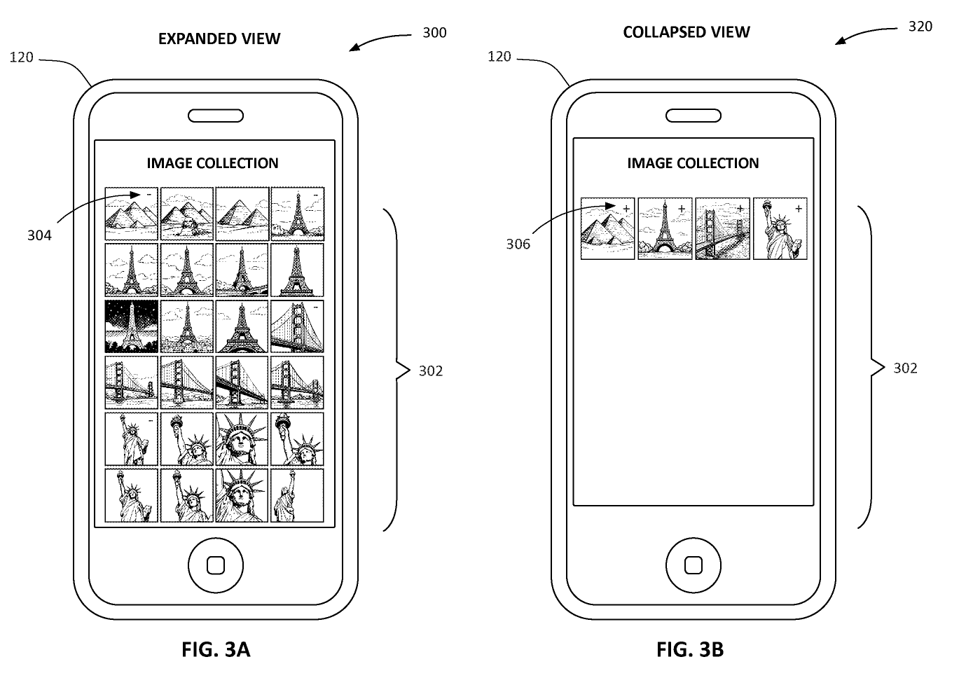

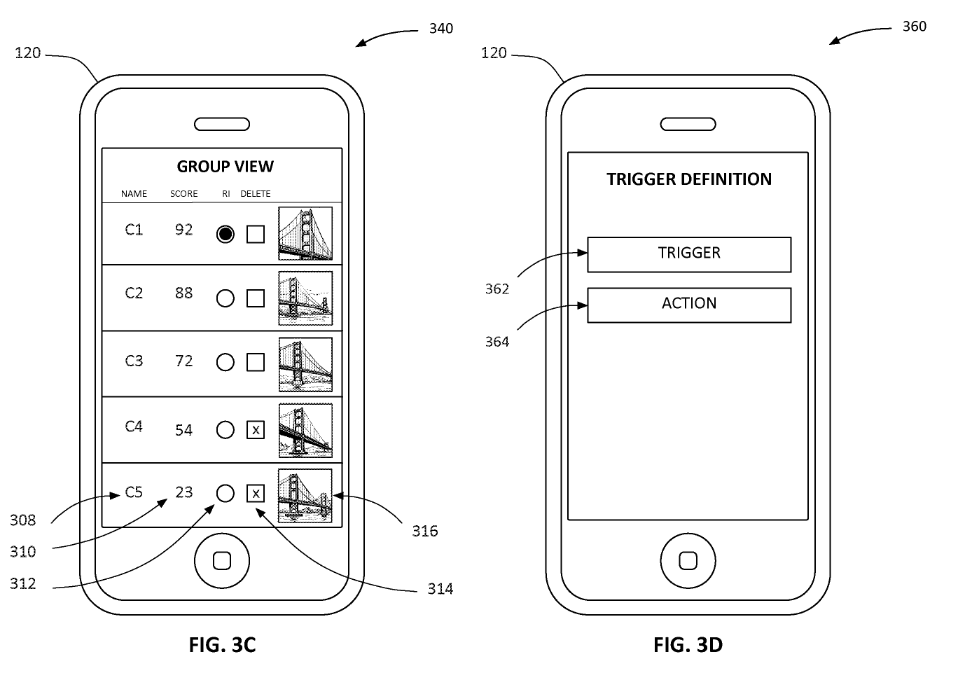

FIG. 3A is a conceptual diagram illustrating a graphical user interface for displaying images in an image collection, according to one or more embodiments. In an expanded view 300, a plurality of images is displayed within a grid 302. The grid 302 may be arranged as rows and columns of image thumbnails and may be scrollable or dynamically resized depending on display characteristics of the user device 120.

Within the grid 302, the displayed images are organized into groups or clusters determined by the image grouping module 126. Each image group 270 is adorned with a collapse control 304, in this case a “-“. In the illustrated embodiment, four groups labeled A–D are shown. Group A includes three images, A1–A3, of the Great Pyramids taken from different capture positions. Group B includes eight images, B1–B8, of the Eiffel Tower taken from different capture positions. Group C includes five images C1–C5 of the Golden Gate Bridge taken from different capture positions. Group D includes eight images D1–D8 of the Status of Liberty taken from different capture positions. In some embodiments, groups include at least one image and may include any number of images without a predetermined upper limit. In some embodiments, groups include at least two images and may include any number of images without a predetermined upper limit.

FIG. 3A illustrates an expanded view of the image collection in which each group is expanded to display its constituent images. In certain embodiments, individual groups may be expanded or collapsed independently without affecting the display state of other groups. Images belonging to the same group may be visually distinguished using one or more visual elements, including labels, background shading, borders, grouping brackets, image naming conventions, or other visual indicators.

In certain embodiments, the grouping shown in grid 302 corresponds to scene-based clusters determined using metadata and image attributes as previously described.

FIG. 3B is a conceptual diagram illustrating a graphical user interface for displaying scene-based groups in a collapsed view using representative images, according to one or more embodiments. In the collapsed view 320, each group is represented by a single representative image 286 selected by the image evaluation module 128.

In the illustrated embodiment, each group A–D is displayed in a collapsed state such that only the representative image 286 for the group is shown. The representative image 286 may correspond to the highest ranked image in the group based on ranking methods described herein.

Each group may include an expansion control 306, which may be displayed as a graphical icon such as a “+” symbol, arrow, or other interactive control. Selection of the expansion control 306 by the user 102 causes the corresponding group to expand to reveal the constituent images within the group. Similarly, the group may be collapsed again using a collapse control.

The collapsed view allows the user 102 to rapidly navigate among scenes represented within the image collection without displaying every image simultaneously. This interface therefore improves navigation efficiency when large numbers of images are present.

FIG. 3C is a conceptual diagram illustrating a graphical user interface for displaying images associated with a selected scene-based group in a group view 340, according to one or more embodiments. The interface may be presented in response to a user selecting a group from the views illustrated in FIG. 3A or FIG. 3B.

In the subset view, images belonging to the selected group are displayed individually in a list or row-based format. Each row corresponds to a particular image 200 in the group and may include one or more associated data elements.

In the example shown, each row includes an image name 308, an image score 310, a representative image indicator 312, a deletion recommendation control 314, and a thumbnail 316 representation of the image 200.

The image name 308 may correspond to the image name field 204 stored within the image metadata structure described in connection with FIG. 2A. The image score 310 represents a ranking value computed by the image evaluation module 128. The ranking may be based on a combination of quality and representativeness scores, or on other scoring methods.

The representative image indicator 312 identifies whether the corresponding image has been selected as the representative image 286 for the group. In certain embodiments, the representative image 286 may be visually emphasized or automatically positioned at the top of the list to facilitate identification.

The deletion recommendation control 314 indicates whether the system has recommended deletion of the image. Such recommendations may be generated when an image is determined to be redundant or duplicative of other images within the group. In this context, redundancy does not necessarily imply exact duplication but may include images that are substantially similar in scene composition, subject matter, or viewpoint.

The user 102 may interact with the rows displayed in FIG. 3C to perform actions such as confirming a representative image 286 , deleting images, rejecting deletion suggestions, or otherwise modifying group contents. In certain embodiments, selecting a row may cause the corresponding image to be marked for deletion or may initiate a confirmation prompt.

The subset view facilitates ranking and evaluation of images within the group and provides a user interface through which the recommendations generated by the image evaluation module 128 may be reviewed and acted upon. In certain embodiments, the images may be ordered from highest to lowest score, so that the most representative or highest-quality image appears first.

In certain embodiments, the graphical user interfaces illustrated in FIGS. 3A–3C are dynamically generated based on data produced by the image grouping module 126, the image evaluation module 128, and the trigger detection module 132. Unlike conventional image browsing interfaces that display images solely according to chronological ordering or static folders, the interfaces described herein reflect a computed organizational structure derived from scene similarity, subject analysis, spatial metadata, and ranking calculations. The image presentation module 130 retrieves grouping information, ranking data, and suggested edits stored within image 200 data structure and image group 270 data structure and renders the interfaces accordingly. As grouping results or evaluation scores change—such as when additional images are captured, images are deleted, or ranking weights are modified—the graphical interfaces may be automatically updated to reflect revised group membership, representative image 286 selection, and deletion recommendations. In this manner, the user interface operates as an interactive visualization of the underlying image analysis and clustering processes performed by the system 100, allowing the user 102 to confirm, modify, or override automated decisions generated by the system while preserving consistency between displayed content and stored metadata.

FIG. 3D is a conceptual diagram illustrating a graphical user interface for specifying a trigger definition 360 including at least one trigger and an associated trigger action, according to one or more embodiments. When invoked, the trigger control 362 presents a graphical user interface enabling the user to define a trigger. The trigger can be a simple trigger, relying on a single condition, or a complex trigger, based on multiple conditions. The conditions comprising the triggers can be system-defined and/or user-defined. In some embodiments, the condition can be a prompt that is fed to local AI module 136 and/or the remote AI module 176 for evaluation.

When invoked, the action control 364 presents a graphical user interface enabling the user to define an action. The action can be a simple action, performing a single operation, or a complex action, performing multiple operations. The operations comprising the actions can be system-defined and/or user-defined. In some embodiments, the operation can be a prompt fed to the local AI module 136 and/or the remote AI module 176 for execution.

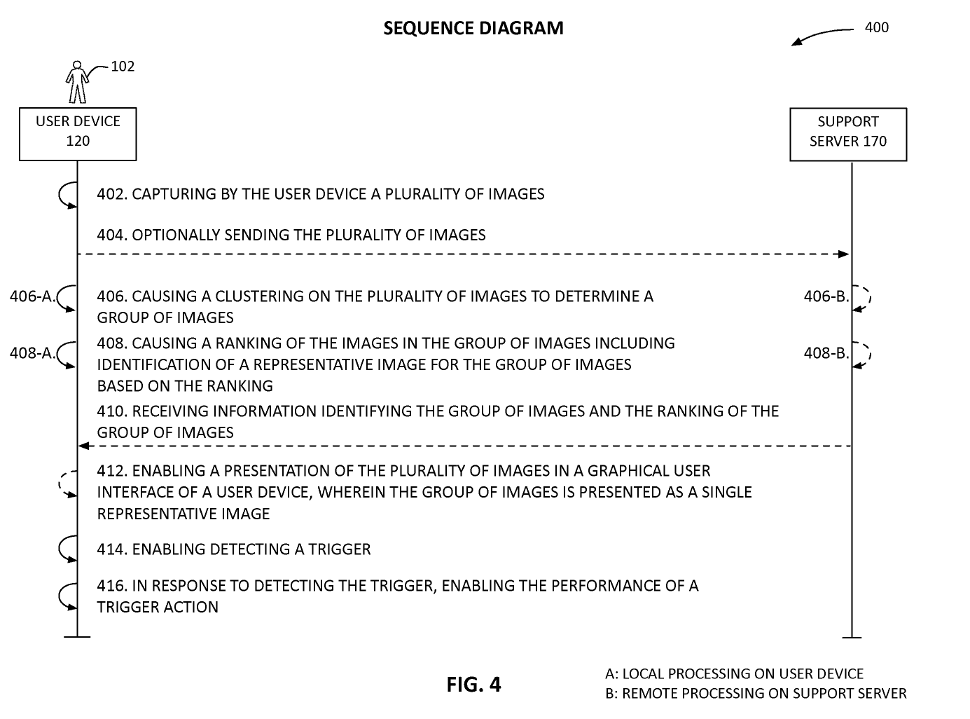

FIG. 4 is a sequence diagram 400 illustrating interactions between a user device and a support server for grouping images, ranking images within a group, presenting representative images, and performing trigger-based curation, according to one or more embodiments.

System 100 includes a user device 120 and a support server 170 communicatively connected through network 104. In certain embodiments, the user device 120 is capable of independently performing the techniques described herein, including image grouping, evaluation, and presentation. However, when available, the support server 170 may provide additional computational resources that improve accuracy, processing speed, or model fidelity. In many implementations, images 200 captured by the user device 120 are uploaded to remote storage associated with the support server 170 as part of routine cloud backup operations. Accordingly, leveraging the support server 170 to perform certain computational tasks may reduce processing load on the user device 120 while improving the performance of the techniques described herein.

At step 402, the user device 120 captures one or more images within a geographic region during a capture session. The captured images may depict one or more scenes and may include repeated captures of substantially the same scene. The images may include arbitrary visual content such as people, landscapes, landmarks, objects, or other subject matter. During capture, metadata associated with the images may also be generated, including location information, device orientation, and facial analysis information as described previously.

At step 404, the user device 120 may optionally transmit the captured images to the support server 170 through network 104. Transmission may occur immediately after capture or may occur at a later time depending on network connectivity, device configuration, or user preferences. For example, images may be queued locally and transmitted when network connectivity becomes available.

At step 406, the image grouping module 126 of the image management module 124 groups the images into one or more scene-based groups according to the grouping techniques described herein. The grouping process may utilize metadata fields, visual embeddings, spatial information, subject faces, contextual information, and other attributes stored in data structures such as those described with respect to FIGS. 2A–2C. When the user device 120 is connected to the support server 170, a remote image grouping module 172 executing on the support server 170 may perform the grouping operation using computational resources and artificial intelligence models available to the remote AI module 176.

At step 408, the image evaluation module 128 of the image management module 124 evaluates the images within each scene-based group and determines a representative image 286 for each group. The representative image 286 may be selected based on ranking methods that consider image quality, representativeness, subject presence, and other evaluation metrics. When the support server 170 is available, a remote image evaluation module 174 executing on the support server 170 may perform the evaluation using models or resources available to the remote AI module 176.

At step 410, when grouping or evaluation is performed remotely, the support server 170 transmits information identifying the resulting scene-based groups and the corresponding representative images 286 to the user device 120. The transmitted information may include group identifiers, image membership data, ranking information, representative image indicators, and optionally deletion or archival recommendation data.

At step 412, the image presentation module 130 of the image management module 124 generates a graphical user interface representation of the grouped images. In certain embodiments, the graphical interface presents each scene-based group using the representative image 286 while other images in the group are initially hidden or collapsed. This presentation enables efficient navigation of large image collections by allowing a user to browse scenes rather than individual images and to selectively expand a group for review and curation.

In some embodiments, the image management module 124 may determine that the user device 120 has entered an idle state prior to presenting a curation interface. An idle state may correspond to a condition in which the user device 120 is not actively capturing images and the user 102 is not actively interacting with the user device 120. The idle state may be determined by evaluating an idle-state condition based on one or more signals obtained from the user device 120. Such signals may include, for example, absence of image capture activity, absence of user interaction with a camera application, expiration of a threshold inactivity period, motion sensor data indicating that the device is stationary or moving slowly, device usage information indicating that no foreground application is actively being used, or device status indicators such as screen lock state or display inactivity. When two or more of these signals indicate inactivity, the image management module 124 may determine that the user device 120 is in an idle state and may present a user interface for curating images captured during the capture session, including review of representative images and curation of redundant images within the scene-based groups. At step 414, the trigger detection module 132 of the image management module 124 monitors system conditions and detects the occurrence of one or more triggers. Triggers may include device state transitions, storage conditions, elapsed time since leaving a geographic area of capture, receipt of new images, deletion of images, or user-defined events.

At step 416, in response to detecting a trigger, the trigger detection module 132 initiates one or more trigger actions 134. Trigger actions may include regrouping images, recomputing representative images 286, prompting user confirmation of suggested edits, recommending deletion of redundant images, or executing user-defined rules. Execution of trigger actions may cause the graphical interface presented by the image presentation module 130 to update to reflect revised grouping or ranking results.

Through the sequence illustrated in FIG. 4, the system 100 enables automated grouping, evaluation, and presentation of images while allowing adaptive updates based on device conditions and user interaction.

Furthermore, the separation between local processing performed on user device 120 and optional processing performed on support server 170 enables adaptive allocation of computational tasks depending on connectivity and available resources. By distributing operations such as clustering and evaluation between the user device 120 and the support server, the system can maintain responsive interaction while still leveraging more computationally intensive analysis when remote resources are available. The result is a coordinated computing architecture that improves the technical functioning of image management systems rather than merely presenting information in a different format.

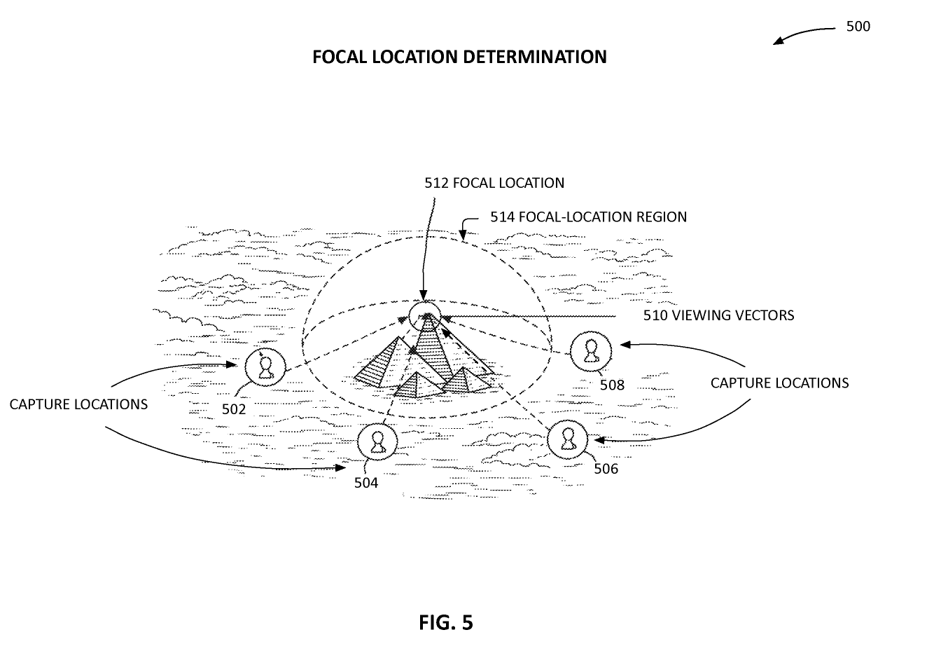

FIG. 5 is a diagram illustrating the determination of a focal location 512 associated with a depicted scene using image information associated with a plurality of image capture locations 502, 504, 506, and 508, according to one or more embodiments. As shown in FIG. 5, a plurality of images may be captured from different physical positions surrounding a common depicted scene or subject. Although four capture locations are shown for ease of illustration, any suitable number of capture locations may be used.

In some embodiments, the system may determine respective viewing vectors 510 associated with images captured at the capture locations 502-508. A viewing vector 510 may indicate a direction in which the corresponding image was captured, and may be determined based on one or more of orientation information, motion information, focal distance, depth information, image content analysis, or other metadata associated with the image. The viewing vectors 510 may be projected outward from the respective capture locations 502-508 toward a common depicted scene.

In some embodiments, the system may determine the focal location 512 based on convergence of the viewing vectors 510. For example, the focal location 512 may correspond to an intersection point, a closest point of convergence, a least-squares estimated location, or another inferred location associated with a subject, landmark, object, or scene toward which multiple images are directed. Thus, even where the respective capture locations 502-508 differ, the system may determine that the corresponding images depict a common scene based at least in part on convergence of the viewing vectors 510 toward the focal location 512.

In some embodiments, the focal location 512 may be associated with a focal-location region 514. The focal-location region 514 may correspond to an area surrounding the focal location 512, such as a radius, boundary, zone, or other region associated with the depicted scene. In some embodiments, determining that two or more images are associated with the focal location 512 and/or the focal-location region 514 may be used to group the images into a common scene-based image group, select a representative image for the group, identify redundant images, or support user-interface navigation among grouped images.

In some embodiments, geographic region 262 may define a capture-area context associated with a plurality of images, such as an area in which the images were captured during a common capture session. Focal location 512, however, may define an inferred scene-specific location derived from image-related information, such as viewing direction, image content, depth information, focal distance, or other metadata. Focal-location region 514 may define an area associated with focal location 512. Accordingly, geographic region 262 need not be coextensive with focal-location region 514. For example, a single geographic region 262 may include multiple distinct focal locations 512 and corresponding focal-location regions 514 associated with different depicted scenes or subjects.

Thus, images captured at different positions within geographic region 262 may nevertheless be grouped together based on association with the same focal location 512 and/or focal-location region 514.

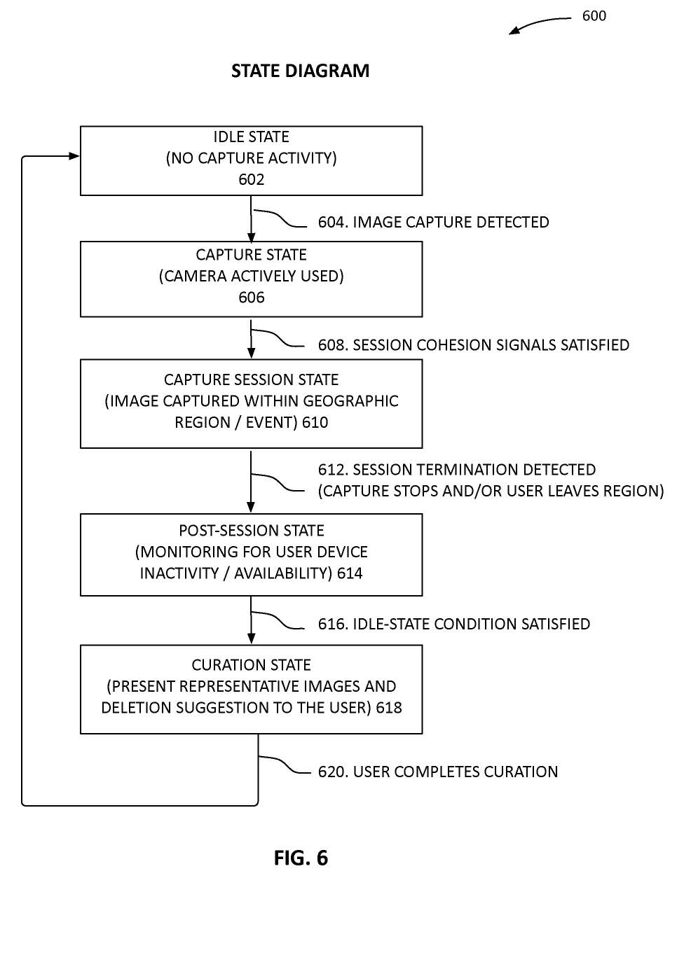

FIG. 6 is a state diagram 600 illustrating the workflow in the curation system 100 according to some embodiments. In some embodiments, the operation of the system 100 for automating image curation may be described using a state-based workflow (state diagram 600) implemented by a user device 120 or associated processing system. The workflow may transition through a plurality of states corresponding to different phases of image capture and curation.

At step 602, the image management module 124 is in an idle state awaiting image capture activity. The image management module 124 transitions from the idle state to the capture state upon detection of image capture activity 604. image capture activity 604 can include capturing an image using the camera integrated with the user device 120. Images can also be obtained from external sources such as through syncing the image collection 138 on the user device 120 with the image collection 138 maintained on the support server 170.

At step 606, the image management module 124, in coordination with system 100, operates in a capture state. During the capture state, the user device 120 captures images using a camera application. While in the capture state, the image management module 124 monitors session cohesion condition signals associated with image capture activity, device motion, geographic location, and user interactions. Based on these session cohesion condition signals, the image management module 124 determines that a capture session state 610 has begun when image capture activity occurs within a geographic region and satisfies the session cohesion condition 608 described above.

At step 610, the image management module 124, in coordination with system 100, operates in a capture session state. During the capture session state, the system 100 accumulates captured images and associated metadata such as timestamps, capture locations, device orientation, and contextual signals. The system 100 may also perform preliminary analysis of the captured images, including identifying scenes, computing focal locations, and determining candidate image groupings. The image management module 124 transitions from the capture session state to a post-session state when one or more session termination conditions are detected 612. Such termination conditions may include, for example, cessation of image capture activity, detection that the user device 120 has departed the geographic region associated with the capture session, or detection of discontinuities in the session cohesion signals.

At step 614, the image management module 124, in coordination with system 100, operates in a post-session state. During the post-session state, the image management module 124 monitors the activity of the user device 120 to determine if the user is idle and might be available for curation activities. As previously described, the user may be determined to be idle based on signals such as absence of user interaction, expiration of a threshold inactivity period, limited motion of the user device 120, device lock state, or other indicators that the user is not actively interacting with the user device 120. The image management module 124 transitions from the capture session state to a post-session state when the idle-state conditions are satisfied 616.

At step 618, the image management module 124, in coordination with system 100, operates in a curation state. Upon transitioning to the curation state, the image management module 124 causes the presentation of a curation interface to the user. In the curation state, the system may present representative images 286 for one or more groups of images identified within the capture session and may request user confirmation of representative images 286 and deletion of redundant images. In this manner, the state-based workflow enables image curation to occur at a time when the user is more likely to have available attention, rather than interrupting the image capture activity during the capture session. As the user completes curation 620, the image management module 124 transitions back to idle state, waiting for future capture activity.

### Process Overview

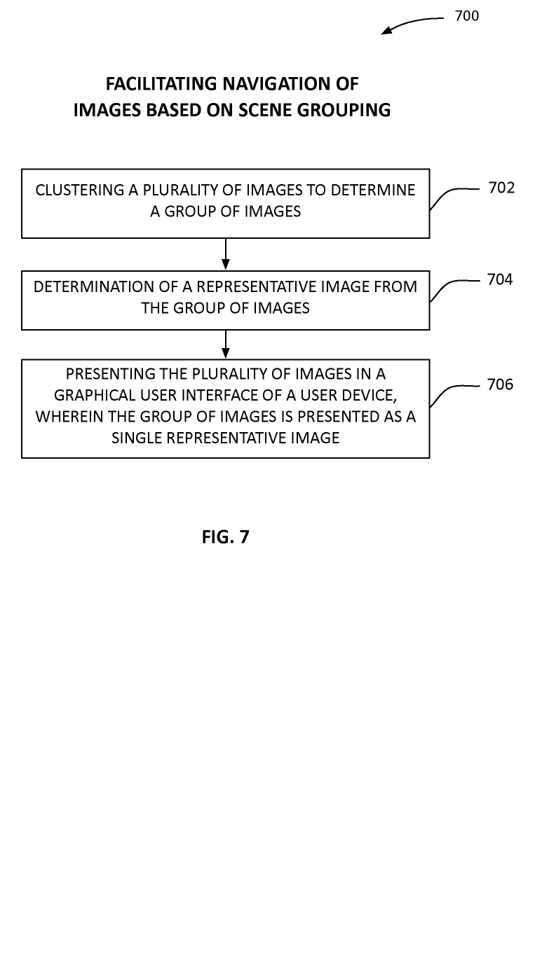

FIG. 7 is a flow diagram 700 for facilitating navigation among images using scene-based grouping and representative-image presentation, according to one or more embodiments. Although the method steps are described in conjunction with the systems of FIGS. 1-6, persons of ordinary skill in the art will understand that any system configured to perform the method steps, in any order, is within the scope of the present disclosure. In certain embodiments, the process is performed by image management module 124 executing on user device 120, optionally in cooperation with support server 170 through network 104.

At step 702, the image management module 124 clusters a plurality of images 200 to determine one or more groups of images. In certain embodiments, the plurality of images corresponds to images stored in image collection repository 138 on user device 120. The clustering operation may be applied to the entire image collection or to a subset of images selected based on time, location, user input, or trigger conditions detected by trigger detection module 132.

The clustering operation may be performed by image grouping module 126 and may utilize attributes stored in image metadata structures such as those described in FIGS. 2A–2C. In certain embodiments, clustering may be based on one or more of visual embeddings, subject faces stored in face list 206, capture location 208, temporal proximity, contextual metadata, and orientation parameters 214–218. In some embodiments, focal location 210 may additionally be used to improve determination that images captured from different positions, viewpoints, or times correspond to a common scene.

In some embodiments, images are assigned to exactly one group, while in other embodiments images may belong to multiple groups depending on similarity thresholds or contextual relationships. In certain implementations, clustering may be performed entirely on user device 120, entirely on support server 170 using remote image grouping module 172 and remote AI module 176, or through a cooperative process in which preliminary grouping occurs locally and refinement occurs remotely.

At step 704, image management module 124 determines a representative image 286 for the group of images identified in step 702. In certain embodiments, this operation is performed by image evaluation module 128. Determination of the representative image 286 may include ranking the images within the group according to one or more ranking methods stored within image group 270.

In certain embodiments, ranking may be based on a combination of factors including: image quality metrics, representativeness relative to the group centroid or aggregate embedding, presence of subject faces, image composition, user preference signals, and ranking weights associated with ranking methods 278 and weights 280.

The ranking process may also identify redundant images within the group. Redundant images may include images that are not exact duplicates but are sufficiently similar in scene composition, viewpoint, or subject matter such that they provide limited additional informational value. These images may be marked as candidates for deletion, archival, or compression. Similar to the clustering operation, the ranking and representative image 286 determination may be performed locally on user device 120, remotely on support server 170 using remote image evaluation module 174 and remote AI module 176, or using a hybrid approach.

At step 706, image management module 124 presents the plurality of images in a graphical user interface generated by image presentation module 130 on user device 120. In certain embodiments, the user interface initially presents each group of images as a single representative image 286 corresponding to the image selected in step 704. This presentation may correspond to the collapsed group view described in connection with FIGS. 3A–3C.

Based on user interaction, the graphical interface may expand a group to reveal the images included in the group. In expanded views, the interface may display ranking information, representative image 286 indicators, and deletion recommendations generated during step 704. In certain embodiments, images suggested for deletion or archival may be visually distinguished through icons, highlighting, or other interface elements. The user may confirm, reject, or modify the suggested actions, and such interactions may update ranking weights or confirmation status fields stored in image group 270.

Through the sequence illustrated in FIG. 7, the system 100 enables automated organization of image collections 138 into scene-based groups while providing an efficient graphical interface for navigating, reviewing, and managing large numbers of images.

In certain embodiments, the process illustrated in FIG. 7 improves the operation of computing systems that manage large collections of digital images by reducing the computational and interface complexity associated with navigating and evaluating large image libraries. Conventional image browsing systems typically present images in chronological order or simple folders, requiring users to visually inspect large numbers of individual images. The techniques described herein instead cluster images based on spatial attributes, subject analysis, and scene similarity, and determine representative images 286 that summarize each group. By presenting groups through representative images 286 and enabling selective expansion of clusters, the system reduces the number of interface elements that must be rendered and processed during navigation. Additionally, the ranking and redundancy analysis performed during representative image 286 determination allow the system to identify images that provide limited additional informational value relative to others in the same scene. Because clustering, ranking, and representative image 286 selection can be performed locally, remotely, or cooperatively between user device 120 and support server 170, the system can adapt processing to available computational resources while maintaining responsive interaction on the user device 120. As a result, the process illustrated in FIG. 7 enables more efficient use of computing resources while improving the usability of image navigation interfaces.

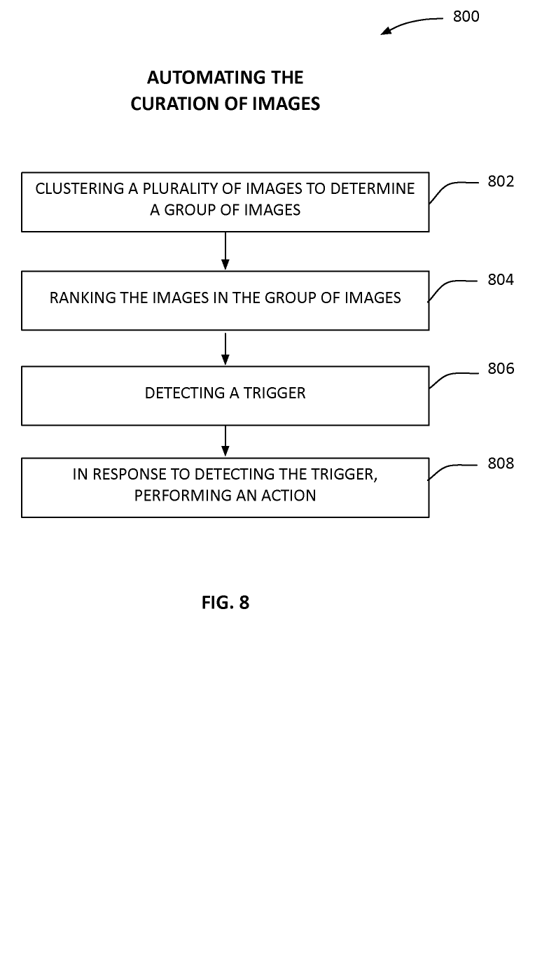

FIG. 8 is a flow diagram 800 for managing an image collection using clustering, ranking, trigger detection, and trigger-based action, according to one or more embodiments. Although the method steps are described in conjunction with the systems of FIGS. 1-7, persons of ordinary skill in the art will understand that any system configured to perform the method steps, in any order, is within the scope of the present disclosure. In certain embodiments, the process is performed by image management module 124 executing on user device 120, optionally in cooperation with support server 170 through network 104.

At step 802, image management module 124 clusters a plurality of images 200 to determine one or more groups of images using the techniques previously described herein. In certain embodiments, clustering is performed by image grouping module 126. The plurality of images may correspond to images stored in image collection repository 138 on user device 120 or images accessible through support server 170. Clustering may be performed on the entire collection or a subset of images determined based on time ranges, geographic regions, trigger events, or user input. In certain embodiments, clustering may consider one or more attributes stored in data structures described in FIGS. 2A–2C, including capture location 208, focal location 210, focal distance 212, orientation parameters 214–218, subject faces stored in face list 206, and visual feature embeddings. In some embodiments, each image is assigned to exactly one group, while in other embodiments images may belong to multiple groups depending on similarity thresholds. The clustering operation may be performed locally on user device 120, remotely by remote image grouping module 172 executing on support server 170 using remote AI module 176, or cooperatively between the two.

At step 804, image management module 124 ranks the images within the group using the techniques previously described herein. In certain embodiments, ranking is performed by image evaluation module 128. The ranking process may compute one or more scores for each image within the group, such as a quality score, representativeness score, or composite score. Ranking may utilize ranking methods 268 and associated weights 280 stored in image group 270. The highest-ranked image may be designated as a representative image 286 for the group, while lower-ranked images may be identified as redundant or candidates for deletion, archival, or compression. In some embodiments, ranking results and suggested edits may be stored in suggested edits field 282 and confirmation status field 284 of image group 270. Similar to clustering, ranking may occur locally on user device 120, remotely on support server 170 using remote image evaluation module 174 and remote AI module 176, or through a hybrid approach.

At step 806, image management module 124 detects a trigger using the techniques previously described herein. In certain embodiments, trigger detection is performed by trigger detection module 132. A trigger may correspond to a condition indicating that additional processing should occur within the system. Example triggers include, but are not limited to:

• detection that the user device 120 has left a geographic area in which images were previously captured • detection that a predetermined period of time has elapsed since the user device 120 departed a capture region • detection that available storage on the user device 120 has fallen below a threshold • capture of a new image by the user device 120 • deletion of an image from the image collection • receipt of an image from an external source, such as a download or message • detection of a user-defined rule or scheduled event.

The trigger detection module 132 may monitor device sensors, storage systems, network activity, and application events to determine when such conditions occur.

At step 808, in response to detecting the trigger, image management module 124 performs one or more actions associated with the detected trigger. In certain embodiments, the actions correspond to trigger actions 134 executed by the system. Example actions include:

• causing image grouping module 126 to recompute clusters for all or a subset of images • causing image evaluation module 128 to recompute rankings or representative images 286 for one or more image groups 270 • identifying and suggesting deletion or archival of redundant images • prompting the user 102 to confirm or modify the representative image 286 for an image group 270 • updating data structures such as image metadata 200 or image group 270 • synchronizing grouping or ranking information with support server 170 • executing a user-defined rule associated with the detected trigger.

Execution of the action may also cause updates to graphical interfaces generated by image presentation module 130 so that grouping results, representative images 286, or deletion suggestions reflect the updated state of the image collection.

Through the sequence illustrated in FIG. 8, the system 100 enables adaptive management of image collections by combining scene-based clustering, ranking of images within clusters, detection of system conditions, and responsive actions that maintain organization and improve navigation of images.

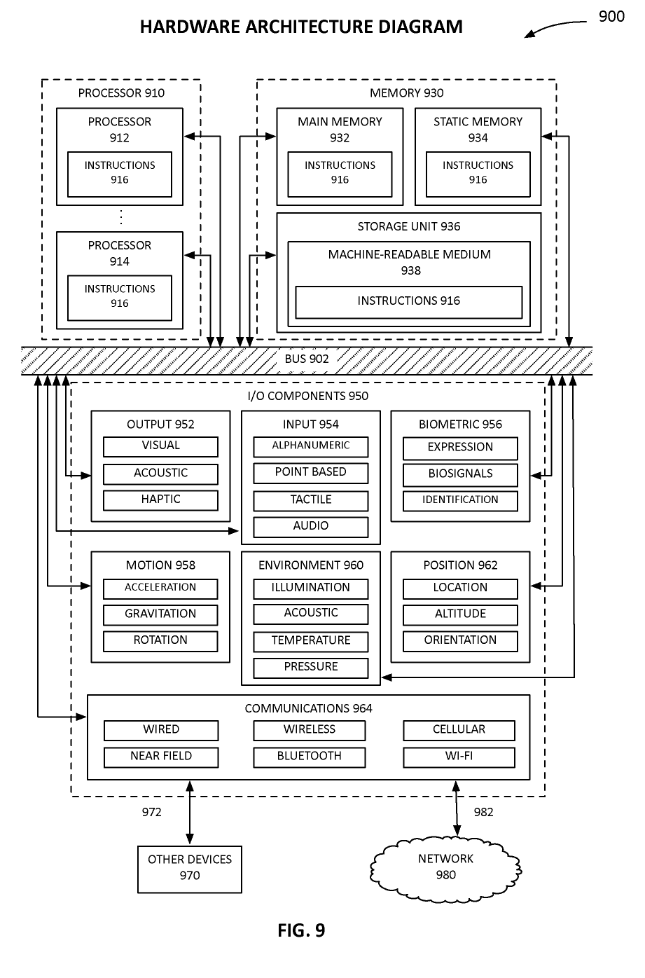

FIG. 9 is a block diagram illustrating the components of a machine 900, according to some embodiments, according to one or more embodiments. The machine 900 is able to read instructions from a machine-readable medium 938 (e.g., a machine-readable storage medium) and perform any one or more of the methodologies discussed herein. Specifically, FIG. 9 shows a diagrammatic representation of the machine 900 in the example form of a computer system, within which instructions 916 (e.g., software, a program, an application, an applet, an app, client, or other executable code) for causing the machine 900 to perform any one or more of the methodologies discussed herein can be executed. In alternative embodiments, the machine 900 operates as a standalone device or can be coupled (e.g., networked) to other machines 900. In a networked deployment, the machine 900 may operate as a server machine or a client machine in a server-client network environment, or as a peer machine in a peer-to-peer (or distributed) network environment. The machine 900 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smart phone, a mobile device, a wearable device (e.g., a smart watch), a smart home device (e.g., a smart appliance), a digital picture frame, a TV, an Internet-of-Things (IoT) device, a camera, other smart devices, a web appliance, a network router, a network switch, a network bridge, or any machine capable of executing the instructions 916, sequentially or otherwise, that specify actions to be taken by the machine 900. Further, while only a single machine 900 is illustrated, the term "machine" shall also be taken to include a collection of machines 900 that individually or jointly execute the instructions 916 to perform any one or more of the methodologies discussed herein.

In various embodiments, the machine 900 comprises processors 910, memory 930, and I/O components 950, which can be configured to communicate with each other via a bus 902. In an example embodiment, the processors 910 (e.g., a central processing unit (CPU), a reduced instruction set computing (RISC) processor, a complex instruction set computing (CISC) processor, a graphics processing unit (GPU), a tensor processing unit (TPU), a language processing unit (LPU), a neural processing unit (NPU), a digital signal processor (DSP), an application specific integrated circuit (ASIC), a radio-frequency integrated circuit (RFIC), another processor, or any suitable combination thereof) include, for example, a processor 912 and a processor 914 that may execute the instructions 916. The term "processor" is intended to include multi-core processors 910 that may comprise two or more independent processors 912, 914 (also referred to as "cores") that can execute instructions 916 contemporaneously. Although FIG. 9 shows multiple processors 910, the machine 900 may include a single processor 910 with a single core, a single processor 910 with multiple cores (e.g., a multi-core processor 910), multiple processors 912, 914 with a single core, multiple processors 910, 912 with multiples cores, or any combination thereof.

The memory 930 comprises a main memory 932, a static memory 934, and a storage unit 936 accessible to the processors 910 via the bus 902, according to some embodiments. The storage unit 936 can include a machine-readable medium 938 on which are stored the instructions 916 embodying any one or more of the methodologies or functions described herein. The instructions 916 can also reside, completely or at least partially, within the main memory 932, within the static memory 934, within at least one of the processors 910 (e.g., within the processor's cache memory), or any suitable combination thereof, during execution thereof by the machine 900. Accordingly, in various embodiments, the main memory 932, the static memory 934, and the processors 910 are considered machine-readable medium 938.

As used herein, the term "memory" refers to a machine-readable medium 938 able to store data temporarily or permanently and may be taken to include, but not be limited to, random-access memory (RAM), read-only memory (ROM), buffer memory, flash memory, and cache memory. While the machine-readable medium 938 is shown, in an example embodiment, to be a single medium, the term "machine-readable medium" should be taken to include a single medium or multiple media (e.g., a centralized or distributed database, or associated caches and servers) able to store the instructions 916. The term "machine-readable medium" shall also be taken to include any medium, or combination of multiple media, that is capable of storing instructions (e.g., instructions 916) for execution by a machine (e.g., machine 900), such that the instructions 916, when executed by one or more processors of the machine 900 (e.g., processors 910), cause the machine 900 to perform any one or more of the methodologies described herein. Accordingly, a "machine-readable medium" refers to a single storage apparatus or device, as well as "cloud-based" storage systems or storage networks that include multiple storage apparatus or devices. The term "machine-readable medium" shall accordingly be taken to include, but not be limited to, one or more data repositories in the form of a solid-state memory (e.g., flash memory), an optical medium, a magnetic medium, other non-volatile memory (e.g., erasable programmable read-only memory (EPROM)), or any suitable combination thereof. The term "machine-readable medium" specifically excludes non-statutory signals per se.

The I/O components 950 include a wide variety of components to receive input, provide output, produce output, transmit information, exchange information, capture measurements, and so on. In general, it will be appreciated that the I/O components 950 can include many other components that are not shown in FIG. 9. Likewise, not all machines will include all I/O components 950 shown in this exemplary embodiment. The I/O components 950 are grouped according to functionality merely for simplifying the following discussion, and the grouping is in no way limiting. In various example embodiments, the I/O components 950 include output components 952 and input components 954. The output components 952 include visual components (e.g., a display such as a plasma display panel (PDP), a light emitting diode (LED) display, a liquid crystal display (LCD), a projector, or a cathode ray tube (CRT)), acoustic components (e.g., speakers), haptic components (e.g., a vibratory motor), other signal generators, and so forth. The input components 954 include alphanumeric input components (e.g., a keyboard, a touch screen configured to receive alphanumeric input, a image-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

In some further example embodiments, the I/O components 950 include biometric components 956, motion components 958, environmental components 960, position components 962, among a wide array of other components. For example, the biometric components 956 include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram based identification), and the like. The motion components 958 include acceleration sensor components (e.g., accelerometer), gravitation sensor components, rotation sensor components (e.g., gyroscope), and so forth. The environmental components 960 include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensor components (e.g., machine olfaction detection sensors, gas detection sensors to detect concentrations of hazardous gases for safety or to measure pollutants in the atmosphere), or other components that may provide indications, measurements, or signals corresponding to a surrounding physical environment. The position components 962 include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication can be implemented using a wide variety of technologies. The I/O components 950 may include communication components 964 operable to couple the machine 900 to other devices 970 and networks 980 or via a coupling 972 and a coupling 982, respectively. For example, the communication components 964 include a network interface component or another suitable device to interface with the network 980. In further examples, communication components 964 include wired communication components, wireless communication components, cellular communication components, near field communication (NFC) components, BLUETOOTH® components (e.g., BLUETOOTH® Low Energy), WI-FI® components, and other communication components to provide communication via other modalities. The devices 970 may be another machine 900 or any of a wide variety of peripheral devices (e.g., a peripheral device coupled via a Universal Serial Bus (USB)).

Moreover, in some embodiments, the communication components 964 detect identifiers or include components operable to detect identifiers. For example, the communication components 964 include radio frequency identification (RFID) tag reader components, NFC smart tag detection components, optical reader components (e.g., an optical sensor to detect one-dimensional bar codes such as a Universal Product Code (UPC) bar code, multi-dimensional bar codes such as a Quick Response (QR) code, Aztec Code, Data Matrix, Dataglyph, MaxiCode, PDF417, Ultra Code, Uniform Commercial Code Reduced Space Symbology (UCC RSS):2D bar codes, and other optical codes), acoustic detection components (e.g., microphones to identify tagged audio signals), or any suitable combination thereof. In addition, a variety of information can be derived via the communication components 964, such as location via Internet Protocol (IP) geo-location, location via WI-FI® signal triangulation, location via detecting a BLUETOOTH® or NFC beacon signal that may indicate a particular location, and so forth.

In various example embodiments, one or more portions of the network 980 can be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the public switched telephone network (PSTN), a plain old telephone service (POTS) network, a cellular telephone network, a wireless network, a WI-FI® network, another type of network, or a combination of two or more such networks. For example, the network 980 or a portion of the network 980 may include a wireless or cellular network, and the coupling may be a Code Division Multiple Access (CDMA) connection, a Global System for Mobile communications (GSM) connection, or another type of cellular or wireless coupling. In this example, the coupling 82 can implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long range protocols, or other data transfer technology.

In example embodiments, the instructions 916 are transmitted or received over the network 980 using a transmission medium via a network interface device (e.g., a network interface component included in the communication components 964) and utilizing any one of a number of well-known transfer protocols (e.g., Hypertext Transfer Protocol (HTTP)). Similarly, in other example embodiments, the instructions 916 are transmitted or received using a transmission medium via the coupling 972 (e.g., a peer-to-peer coupling) to the devices 970. The term "transmission medium" shall be taken to include any intangible medium that is capable of storing, encoding, or carrying the instructions 916 for execution by the machine 900, and includes digital or analog communications signals or other intangible media to facilitate communication of such software.

Furthermore, the machine-readable medium 938 is non-transitory (not having any transitory signals) in that it does not embody a propagating signal. However, labeling the machine-readable medium 938 "non-transitory" should not be construed to mean that the medium is incapable of movement; the machine-readable medium 938 should be considered as being transportable from one physical location to another. Additionally, since the machine-readable medium 938 is tangible, the machine-readable medium 938 may be considered to be a machine-readable device.

The user device 120 is an example of machine 900. The user device 120 may, in some embodiments, have more or fewer features than machine 900. The support server 170 is also an example of machine 900. In some embodiments, support server 170 will be deployed as a blade server at a cloud hosting facility and will be a stripped-down version of machine 900, including primarily processor(s), memory, and non-volatile storage.

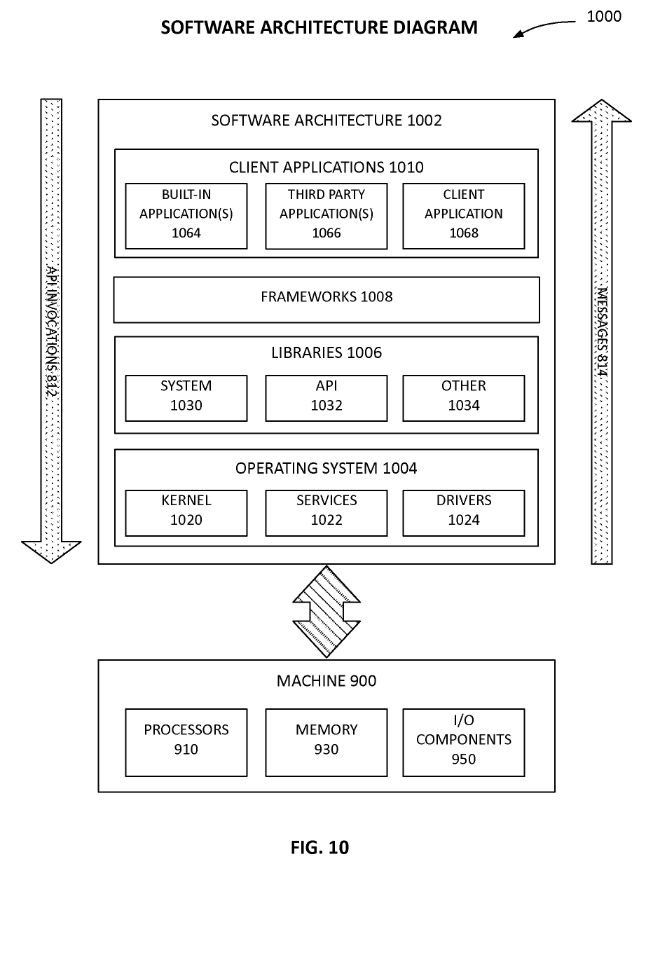

FIG. 10 is a block diagram illustrating an exemplary software architecture diagram 1000, which can be employed on any one or more of the machines 900 described above, according to one or more embodiments. FIG. 10 is merely a non-limiting example of a software architecture, and it will be appreciated that many other architectures can be implemented to facilitate the functionality described herein. Other embodiments may include additional elements not shown in FIG. 10 and not all embodiments will include all of the elements of FIG. 10. In various embodiments, the software architecture 1002 is implemented by hardware such as machine 900 of FIG. that includes processors 910, memory 930, and I/O components 950. In this example architecture, the software architecture 1002 can be conceptualized as a stack of layers where each layer may provide a particular functionality. For example, the software architecture 1002 includes layers such as an operating system 1004, libraries 1006, frameworks 1008, and applications 1010. Operationally, the applications 1010 invoke application programming interface (API) calls 1012 through the software stack and receive messages 1014 in response to the API calls 1012, consistent with some embodiments.

In various implementations, the operating system 1004 manages hardware resources and provides common services. The operating system 1004 includes, for example, a kernel 1020, services 1022, and drivers 1024. The kernel 1020 acts as an abstraction layer between the hardware and the other software layers, consistent with some embodiments. For example, the kernel 1020 provides memory management, processor management (e.g., scheduling), component management, networking, and security settings, among other functionality. The services 1022 can provide other common services for the other software layers. The drivers 1024 are responsible for controlling or interfacing with the underlying hardware, according to some embodiments. For instance, the drivers 1024 can include display drivers, camera drivers, BLUETOOTH® or BLUETOOTH® Low Energy drivers, flash memory drivers, serial communication drivers (e.g., Universal Serial Bus (USB) drivers), WI-FI® drivers, audio drivers, power management drivers, and so forth. In some embodiments, the libraries 1006 provide a low-level common infrastructure utilized by the applications 1010. The libraries 1006 can include system libraries 1030 (e.g., C standard library) that can provide functions such as memory allocation functions, string manipulation functions, mathematic functions, and the like. In addition, the libraries 1006 can include API libraries 1032 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1006 can also include a wide variety of other libraries 1034 to provide many other APIs to the applications 1010.

The frameworks 1008 provide a high-level common infrastructure that can be utilized by the applications 1010, according to some embodiments. For example, the frameworks 1008 provide various graphic user interface (GUI) functions, high-level resource management, high-level location services, and so forth. The frameworks 1008 can provide a broad spectrum of other APIs that can be utilized by the applications 1010, some of which may be specific to a particular operating system 1004 or platform.

According to some embodiments, the applications 1010 are programs that execute functions defined in the programs. The applications 1010 can take different forms, including built-in applications 1064, third-party applications 1066, and client applications 1068. built-in applications 1064 are characterized by being distributed with the operating system. Third-party applications 1066 can be created by developers other than the developer of the operating system. Client applications 1068 typically communicate with a server device over the network to perform a function. Various programming languages can be employed to create one or more of the applications 1010, structured in a variety of manners, such as object-oriented programming languages (e.g., Objective-C, Java, or C++) or procedural programming languages (e.g., C or assembly language). In a specific example, the third-party application 1066 (e.g., an application 1010 developed using the ANDROID™or IOS™software development kit (SDK) by an entity other than the vendor of the particular platform) may be mobile software running on a mobile operating system such as IOS™, ANDROID™, WINDOWS® Phone, or another mobile operating system. In this example, the third-party application 1066 can invoke the API calls 1012 provided by the operating system 1004 to facilitate functionality described herein.

In sum, the present disclosure describes techniques for automated curation of images based on scene-based grouping and group-aware evaluation of collected images. Images may be collected at a user device from one or more sources, including images captured by the user device and images received from other users, devices, or network-based services. In some embodiments, collected images may be associated with one or more capture sessions occurring within respective geographic regions. The system may analyze the collected images and cluster a plurality of the images into scene-based image groups, where membership in a given group is based on a determination that the corresponding images depict the same or a similar scene, subject, landmark, or object. Such determinations may be based on visual characteristics, learned image embeddings, focal-location determinations, and/or other image-related metadata or content-derived information. In some embodiments, focal location may be determined using capture-location information and viewing-vector information derived from device orientation information, such as pitch, yaw, and roll, thereby enabling the system to determine that multiple images captured from different locations are nevertheless directed toward the same or a similar depicted scene, subject, landmark, or object. The system may further evaluate images within a group using one or more scoring techniques, including a composite score based on image quality, representativeness, subject presence, composition, and/or other evaluation metrics. Based on such evaluation, the system may determine a representative image for the group and may identify one or more redundant images for possible deletion, archival, compression, de-emphasis, or other curation treatment. In some embodiments, the system may monitor for one or more triggers based on system conditions and, upon detection of a trigger, may perform a corresponding trigger action according to a trigger-action mapping defined by the system and/or by the user. By way of example, a trigger may correspond to termination of a capture session and detection of an idle state of the user device, and a corresponding trigger action may include presenting a prompt requesting user confirmation of a representative image and/or deletion of one or more redundant images in a scene-based group. Resulting image collections may be presented in a user interface organized according to scene-based grouping, such that image groups may be displayed in collapsed form using representative images, or in expanded form showing multiple images of a group together with information identifying representative and/or redundant images.

One advantage of the proposed techniques includes reducing clutter and redundancy in the display and storage of image collections, thereby improving navigability, organization, and efficient use of device resources, particularly on resource-constrained devices. Another advantage includes enabling groups of images depicting the same or a similar scene, subject, landmark, or object to be represented by representative images, thereby simplifying user interaction with large image collections while preserving access to additional grouped images. Another advantage includes enabling curation activities to be presented to the user in response to one or more triggers, such that the user may be prompted to review representative images and curate redundant images at a time when the corresponding images remain current in the user’s mind and when the user is available to perform the curation. In some embodiments, previously computed grouping and ranking information may be used during navigation, such that the system need not repeatedly analyze an entire image library during interactive browsing, thereby improving efficiency and responsiveness, particularly for large image collections. Accordingly, the disclosed techniques can improve the timing, relevance, effectiveness, and computational efficiency of image curation and navigation.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A method of operating a user device to automate curation of images based on scene-based grouping, the method comprising: obtaining a plurality of images during a capture session occurring within a geographic region; grouping at least a portion of the plurality of images into a group of images based on a scene depicted in each image within the capture session; ranking the images in the group of images based at least in part on representativeness; and in response to detecting a trigger associated with termination of the capture session, performing a trigger action using the ranking to identify at least one image from the group of images.

2. The method of claim 1, wherein obtaining the plurality of images comprises: capturing at least one of the plurality of images using the user device.

3. The method of claim 1, wherein obtaining the plurality of images comprises: receiving at least one of the plurality of images from an other user device of an other user.

4. The method of claim 1, wherein the geographic region is derived from geographic coordinates associated with geographic locations of capture of the plurality of images on a mobile user device.

5. The method of claim 1, wherein the capture session is identified based on a session cohesion condition evaluated from a weighted combination of two or more signals including: time proximity between images of the plurality of images, location proximity between images of the plurality of images, device/application context of the user device capturing the plurality of images, motion state continuity of the user device, environment continuity of the user device, content continuity between images of the plurality of images, and one or more user interaction markers from the user device.

6. The method of claim 1, wherein the grouping of images is further based on focal locations of the plurality of images.

7. The method of claim 6, wherein determining the focal locations of the plurality of images comprises: analyzing visual content of each image to identify a region of the image corresponding to a primary subject or area of visual attention.

8. The method of claim 6, wherein determining the focal locations of the plurality of images comprises: analyzing visual features of each image to determine a focal region corresponding to a subject or object of interest within the image.

9. The method of claim 6, wherein determining the focal locations of the plurality of images comprises: analyzing image data of each image to compute a focal location corresponding to a region of highest visual saliency or subject prominence within the image.

10. The method of claim 1, wherein the ranking of the images in the group of images further comprises: identifying a representative image from the group of images based on one or more image attributes including visual quality and composition; and identifying one or more redundant images for deletion.

11. The method of claim 1, wherein detecting the trigger comprises: monitoring a geographic location of the user device.

12. The method of claim 1, wherein detecting the trigger comprises: detecting a termination of the capture session; and detecting that the user device has entered an idle state following the termination of the capture session.

13. One or more non-transitory computer-readable media storing instructions that, when executed by one or more processors, cause the one or more processors to perform the steps of: clustering at least a portion of a plurality of images into a plurality of groups of images based on a scene depicted in each image; determining a representative image for each of the plurality of groups of images; and presenting the plurality of images in a graphical user interface, wherein the presentation includes: an expanded view of a first group of images, wherein each image in the first group of images is displayed with information identifying inclusion in the first group of images, a collapsed view of a second group of images, wherein the second group of images is represented by a single representative image, and an image of the plurality of images that is not part of any group of images.

14. The computer-readable media of claim 13, wherein an image of the plurality of images is one of: included in a single group of images, included in a plurality of groups of images, and included in no group of images.

15. The computer-readable media of claim 13, wherein the clustering of the images is further based on focal locations of the plurality of images.

16. The computer-readable media of claim 15, wherein determining that the plurality of images share a common focal location comprises: obtaining capture locations associated with the plurality of images; obtaining heading information associated with the plurality of images indicating viewing directions of a camera when the images were captured; projecting, from the capture locations, corresponding viewing vectors based on the heading information; and determining that the viewing vectors intersect or converge within a threshold distance of a common point in three-dimensional space.

17. The computer-readable media of claim 16, wherein the heading information includes camera orientation comprising at least one of yaw, pitch, and roll.

18. The computer-readable media of claim 15, wherein determining focal locations of the plurality of images comprises: determining camera pose information including capture location and viewing direction for each image; projecting viewing vectors from the respective capture locations in accordance with the viewing directions; and identifying a focal location corresponding to a point in space at which two or more of the projected viewing vectors intersect within a threshold tolerance.

19. The computer-readable media of claim 15, wherein determining a focal location comprises: identifying a point in three-dimensional space that minimizes a distance between projected viewing vectors associated with the plurality of images.

20. The computer-readable media of claim 15, wherein determining the representative image comprises: generating the representative image using an AI module.

21. A user device comprising: a memory storing an image management module; and a processor coupled to the memory that executes the image management module to perform the steps of: grouping at least a portion of a plurality of images into a group of images based on a scene depicted in each image; scoring the images in the group of images based at least in part on representativeness; and in response to detecting a trigger associated with a transition from an idle state to a curation state, performing a trigger action using the scoring to identify at least one image from the group of images.

22. The user device of claim 21, wherein detecting the trigger comprises: determining that the user device is in an idle state based on an idle-state condition evaluated from two or more signals including: absence of image capture activity, absence of user interaction with the user device, expiration of a threshold inactivity time, motion sensor data indicating that the user device is stationary or moving slowly, device usage information indicating that the user device is not actively executing a camera application, and device state information indicating that a display of the user device is inactive or locked.

23. The user device of claim 21, wherein detecting the trigger comprises: detecting that image capture activity has ceased; and detecting that the user device has departed a geographic region of a capture session.

24. The user device of claim 21, wherein the detection that the user device has departed n comprises: detecting that the user device has moved beyond a threshold distance from a geographic region of a capture session; and detecting that a threshold time has elapsed since capture activity ceased.

25. The user device of claim 21, wherein the trigger action comprises: presenting a prompt requesting user confirmation of a representative image for the group of images and confirmation of deletion of a redundant image from the group of images.

26. The user device of claim 21, wherein the grouping of the plurality of images and ranking of the group of images comprises:
performing the grouping on one or more of the user devices and a remote server device.

27. The user device of claim 21, wherein the user device transitions through a plurality of operational states, including: a capture session state, a post-session state, an idle state, and a curation state, wherein the trigger action is performed upon transition from the idle state to the curation state.
